(19) United States
(12) Patent Application Publication
(10) Pub. No.: US 2005/0202835 A1
(43) Pub. Date: Sep. 15, 2005

(54) Method and apparatus for providing communication service

(76) Inventors: Toshihiko Sato, Kawasaki (JP); Norio Murakami, Kawasaki (JP)

Correspondence Address: KATTEN MUCHIN ROSENMAN LLP, 575 MADISON AVENUE, NEW YORK, NY, 10022-2585, US

(21) Appl. No.: 10/947,645

(22) Filed: Sep. 22, 2004

(30) Foreign Application Priority Data
Mar. 12, 2004 (JP) JP2004-069924

(51) Int. Cl. H04Q 7/20

(52) U.S. Cl. 455/456.6; 455/456.1

(57) ABSTRACT

When a service requested by a user is provided by communication, a mapping unit uses a prescribed function to map (convert) information that has been entered the auser in order that the user may receive provision of service, or information that has been gathered or acquired in the course of execution of a call connection or communication service. A service generating unit, which generates a service for the user, generates added value (e.g., content) based upon the result of mapping, applies this added value to the service requested by the user and provides the service to the user. Alternatively, on the basis of a converted value obtained, a modification is applied to a service provided by an information provider or to the specifics of the service, and the modified service is supplied to the user.

### BACKGROUND OF THE INVENTION

This invention relates to a method and apparatus for providing a communication service. More particularly, the invention relates to a communication service providing method and apparatus for adding “uncertainty” to the inherent value of various information in communications, thereby providing a communication service upon additionally furnishing the service with elements that give the user a sense of “surprise” or “changeability”. More specifically, the present invention relates to a communication service providing method, and an apparatus for implementing this method, in which a communication service utilized by the user of a mobile information terminal such as a mobile telephone is additionally furnished with elements, such as “discontinuity” and “uncertainty”, that cannot be predicted by the user, thereby making it possible to provide one kind of added value such as “surprise”. Further, it is possible for the present invention to be applied broadly to fixed-telephone and Internet services, etc., and not just to mobile information terminals such as mobile telephones.

In prior-art services such as a service that utilizes location information, the meaning possessed by the information acquired is provided in its existing form as is. A location-information service will be described as one example. A location-information service measures the position of a mobile terminal and provides this information to a user. With a service for verifying present position, the acquired location information is provided to the user together with map data. With an emergency-contact acceptance service provided by a security company, employees of the company hasten to a particular location based upon location information from a terminal at the location. Thus, the prior art is such that what is utilized is only the content formally expressed (signified) by the information.

Further, in online shopping that utilizes a network, there is a prior-art method that employs a price decision system having a degree of surprise, as afforded by a lottery or the like, whereby the interest of the user is aroused to promote sales (e.g., see the specification of JP 2003-150809A). This is a method whereby the user participates in an electronic lottery, selects a pricing system and decides price based upon this pricing system.

A further example of the prior art is a musical performance system in which amusement is enhanced by providing a service having a degree of surprise that allows all users to have fun irrespective of their singing ability (e.g., see the specification of JP 11-283476A). This system assigns hit or miss and prize rankings to song numbers and, if a song number selected by a customer is a winning number, provides the customer with a present commensurate with the ranking.

In the prior art, the value of information relates only to a single-sided aspect of the information; information and value are handled only on the basis of one item of information versus one value. Further, though the prior art is such that the one can change price and award prizes in accordance with a lottery drawing or selection made by a user, with regard to information there is only a one-to-one relationship between information and value. However, it is possible to attach multifaceted significance from a single item of information. By so arranging it that this is achieved, it is possible to provide a user with service upon attaching one kind of added value such as “surprise”.

### SUMMARY OF THE INVENTION

Accordingly, an object of the present invention is to broaden the scope of communication services to users by achieving an information-value relationship in which one item of information can exhibit multiple value (e.g., in which location information is handled as possessing its inherent meaning as well as another meaning separate from its inherent meaning).

Another object of the present invention is to provide a service not expected by the user by generating added value conforming to result of mapping obtained by mapping information that has been entered in order that a user may receive provision of service, or information that has been gathered or acquired in the course of execution of a call connection or communication service, and applying the added value to the service, or by modifying the service itself in accordance with the mapped result.

According to the present invention, the foregoing objects are attained by mapping information that has been entered in order that a user may receive provision of service, or information that has been gathered or acquired in the course of execution of a call connection or communication service; generating added value based upon the result of mapping obtained; and applying the added value to the service and providing the service to the user.

Further, according to the present invention, the foregoing objects are attained by mapping information that has been entered in order that a user may receive provision of service, or information that has been gathered or acquired in the course of execution of a call connection or communication service; modifying the service, or the content thereof, which is provided by an information provider, based upon the result of mapping obtained; and providing the modified service or content thereof to the user.

Further, according to the present invention, the foregoing objects are attained by mapping information that has been entered in order that a user may receive provision of service, or information that has been gathered or acquired in the course of execution of a call connection or communication service; predicting an effective information distribution method based upon the result of mapping obtained and notifying an information provider of this method; receiving distributed information, which has been created taking the distribution method into account, from the information provider; and providing this distributed information to the user.

In accordance with the present invention, formal meaning given from certain information can be provided with multiple value (multiple meanings) based upon the various information which is obtained from a variety of communication environments, and by creating changes or changes in quality of a service provided to a user, it is possible to achieve added value, such as “surprise” or “changeability”, that cannot be predicted by the user.

Other features and advantages of the present invention will be apparent from the following description taken in conjunction with the accompanying drawings.

### BRIEF DESCRIPTION OF THE DRAWINGS

FIG. 1 is a flowchart of basic processing for generating added value according to the present invention;

FIG. 2 is a block diagram of the configuration of an information providing server system according to the present invention;

FIG. 3 is a block diagram illustrating the principal part of another information providing server system according to the present invention;

FIG. 4 illustrates basic models of mapping;

FIG. 5 is a diagram useful in describing linear mapping;

FIG. 6 is a diagram useful in describing non-linear mapping;

FIG. 7 is a graph of a linear mapping function;

FIG. 8 is a graph of a non-linear mapping function;

FIG. 9 illustrates an example of the configuration of a network system to which the present invention is applied;

FIG. 10 is a diagram useful in describing a basic processing configuration in which an information distributing server system provides added value on its own, this diagram illustrating a configuration in which the content of communication is given added value in response to a request from a calling party;

FIG. 11 is a sequence diagram of an online method in the processing configuration of FIG. 10;

FIG. 12 is a sequence diagram of an offline method in the processing configuration of FIG. 10;

FIG. 13 is a diagram useful in describing a basic processing configuration in which an information distributing server system provides added value in association with an information provider;

FIG. 14 is a sequence diagram;

FIG. 15 is a first sequence diagram of a basic processing configuration in which an information distributing server system provides added value relating to an advertising service distributed by an information provider;

FIG. 16 is a second sequence diagram of a basic processing configuration in which an information distributing server system provides added value relating to an advertising service distributed by an information provider;

FIG. 17 is a diagram useful in describing processing for registering a service user;

FIG. 18 is a diagram useful in describing processing for registering an information provider;

FIG. 19 is a diagram useful in describing processing for quantizing map information;

FIG. 20 is a diagram useful in describing a process for deciding designated zones classified by information provider;

FIG. 21 is a diagram useful in describing a process for deciding a user who is to be the object of information distribution;

FIG. 22 is a diagram useful in describing processing for narrowing down users who are to be distributed information;

FIG. 23 is a diagram useful in describing an information distributing server system for implementing information distribution;

FIG. 24 is a diagram useful in describing an information distributing server system for gathering user reaction to distributed information;

FIG. 25 is a diagram useful in describing implementation of a basic processing configuration 1, in which an information distributing server system provides added value on its own;

FIG. 26 is a diagram useful in describing implementation of a basic processing configuration 2, in which an information distributing server system provides added value in association with an information provider;

FIG. 27 illustrates a settlement sequence in case of implementation of basic processing configuration 1, in which an information distributing server system provides added value on its own;

FIG. 28 illustrates a settlement sequence in a case where an ASP engages in a network banking business as well;

FIG. 29 illustrates a settlement sequence in case of implementation of basic processing configuration 2, in which an information distributing server system provides added value in association with an information provider;

FIG. 30 illustrates a settlement sequence in a case where an ASP engages in a network banking business as well;

FIG. 31 illustrates a settlement sequence in case of implementation of basic processing configuration 3, in which an information distributing server system provides added value relating to a distribution and advertising service of an information provider;

FIG. 32 illustrates a settlement sequence in a case where an ASP engages in a network banking business as well;

FIG. 33 is a block diagram of settlement processing executed Dy an ASP;

FIG. 34 is a diagram useful in describing processing in a case where, at implementation of service, an ASP makes payment of a connection agreement fee to a communications carrier in response to billing by the communications carrier;

FIG. 35 is a diagram useful in describing processing in a case where a user makes payment of a monthly fee to a communications carrier in response to billing by the communications carrier;

FIG. 36 is a diagram useful in describing processing in a case where a communications carrier makes payment to an ASP of an amount from which the communications carrier commission has been excluded when collection of the service fee has been made in conformity with collection of a monthly communication fee by the communications carrier;

FIG. 37 is a diagram useful in describing processing in a case where payment is made to an information provider in response to billing for a user fee for content, etc., provided for this service by the information provider;

FIG. 38 is a diagram useful in describing processing in a case where an information provider is billed for cost of a service added on by an ASP and the information provider makes this payment;

FIG. 39 is a diagram useful in describing processing of settlement process steps S1 to S3 illustrated in FIG. 27;

FIG. 40 is a diagram useful in describing processing of settlement process steps S1, S2′, S2″ illustrated in FIG. 28;

FIG. 41 is a diagram useful in describing processing of settlement process steps S6, S7 illustrated in FIG. 27;

FIG. 42 is a diagram useful in describing processing for a case where an ASP also engages in network banking;

FIG. 43 is a diagram useful in describing processing of settlement process steps S11, S12 illustrated in FIG. 31;

FIG. 44 is a diagram useful in describing processing for a case where an ASP also engages in network banking;

FIG. 45 is a conceptual view for a case where an information distributing server system decides the content of a service in cooperation with an information provider;

FIG. 46 illustrates a sequence for a case where the content of a service is decided by an information distributing server system in cooperation with an information provider;

FIG. 47 is another conceptual view for a case where an information distributing server system decides the content of a service in cooperation with an information provider;

FIG. 48 illustrates another sequence for a case where the content of a service is decided by an information distributing server system in cooperation with an information provider;

FIG. 49 is another conceptual view for a case where content of a service is decided by cooperation among promoters of gambling, prize-awarding and event enterprises;

FIG. 50 illustrates a sequence for a case where content of a service is decided by cooperation among promoters of gambling, prize-awarding and event enterprises;

FIG. 51 is a conceptual view for a case where added value is provided to two-party communication;

FIG. 52 illustrates a sequence for a case where added value is provided to two-party communication;

FIG. 53 illustrates a sequence in case of application to communication, such as a bulletin board service, that does not require quick response;

FIG. 54 illustrates a sequence in case of application to communication, such as a voice communication service, that requires quick response;

FIG. 55 illustrates a sequence for implementing smooth communication between an individual having a disability, such as a speech impediment, and an able-bodied individual;

FIG. 56 is a conceptual view for a case where an information provider is provided with added value for enhancing effectiveness of information distribution;

FIG. 57 is a diagram useful in describing the sequence of an active-type service; and

FIG. 58 is a diagram useful in describing the sequence of a passive-type service.

### DESCRIPTION OF THE PREFERRED EMBODIMENTS

### (A) Overview of the Present Invention

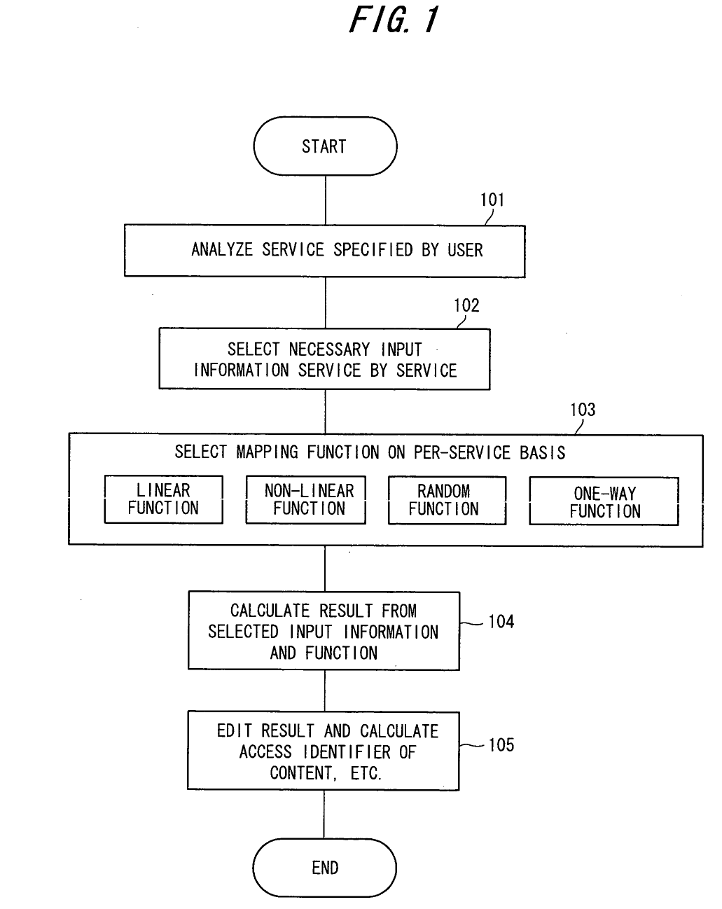

The present invention provides a communication service with elements that give the user a sense of “changeability” and “surprise”, which have not been achieved in communication services heretofore, by linearly or non-linearly mapping information collectable in the course of execution of a call (set-up) connection or communication service in various communication networks such as mobile or fixed networks. As shown in FIG. 1, the basic processing flow for generating added value includes having an information providing server system analyze a service requested by a user (step 101), select, based upon the result of analysis, input information, which is for administering a mapping (conversion), from information that has been entered in order to receive provision of the service (step 102), and select a function used in mapping (step 103). A linear function, non-linear function, random function and one-way function are conceivable as mapping functions. Next, using the mapping function, the information providing server system maps the input information (e.g., position and speed of a mobile terminal and terminal communication time) selected at step 102 (step 104) and provides information (a service) having a different value based upon the result of mapping, or provides added value, which conforms to the result of mapping, to a service (step 105). For example, based upon the result of mapping, the information providing server system calculates a content-access identifier or a parameter that identifies content (information) requested of a content provider or information provider. Next, the information providing server system provides the user with content having the access identifier or parameter or provides added value to content provided to the user. By utilizing the provided information (service), the user is capable of receiving a service different from one provided thus far.

Information input to a basic functional block for creating added value is formal information such as position, speed and time. By mapping this information, it becomes possible to generate an unpredictable result having a degree of unexpectedness, thereby producing “surprise” and “changeability”, and realize a new service area in a communication service. For example, though location information is formal information that in its original form has only numerical significance, such as longitude, latitude and altitude, such formal information can be given a discontinuous meaning by mapping. That is, meaning that creates a “surprise” or “changeability” effect can be imparted to information that expresses a formal meaning. It should be noted that a sense of “surprise” and “changeability” is human emotions that derive from a result that is unpredictable and unexpected.

### (B) First Embodiment

(a) Information Providing Server System

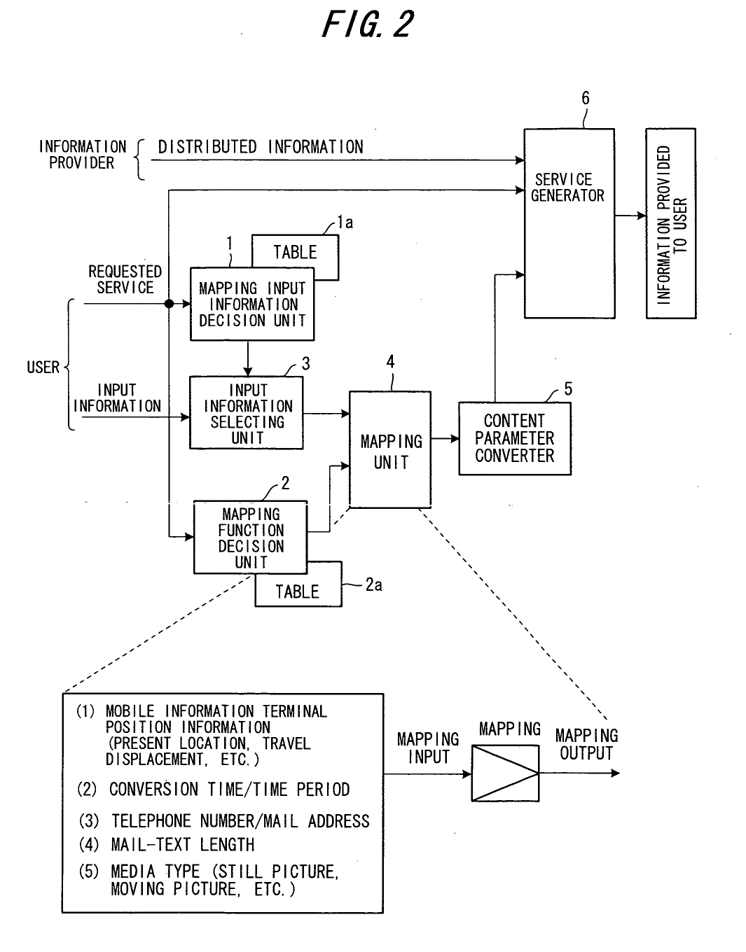

FIG. 2 is a block diagram of the configuration of an information providing server system for implementing the processing flow of FIG. 1. Here a mapping input information decision unit 1 analyzes a service requested by a user and decides input information used in a mapping conversion. A mapping function decision unit 2 decides a mapping function based upon the requested service and inputs the function to a mapping unit 4. An input information selecting unit 3 extracts input information used in a mapping conversion and inputs this information to the mapping unit 4. For example, a correspondence table 1a indicating correspondence between services and input information used in a mapping conversion is retained in the mapping input information decision unit 1, and this table is used by the mapping input information decision unit 1 to decide the input information used in the mapping conversion. Further, a correspondence table 2a indicating the correspondence between services and mapping functions is retained in the mapping function decision unit 2 and is used by the mapping function decision unit 2 to decide the mapping function used in the mapping conversion.

The mapping unit 4, which performs mapping for generating a different meaning (value) from the value originally signified by the input information, applies a mapping conversion to the input from the input information selecting unit 3 using the mapping function. On the basis of result of mapping, the content parameter converter 5 calculates a content access number or a parameter that identifies the content. A service generating unit 6 for generating a service for a user provides content conforming to the content access number or parameter, which content is from multiple items of content provided by an information provider, to the user as information provided for the user. As a result, if the information provided is game software, the software can be provided to the user upon changing the people that appear in the game, the time limit or the degree of difficulty based upon the result of mapping.

The following information relating to a mobile terminal is conceivable as the input information that undergoes a mapping conversion: terminal location information, moving speed, communication time and length of time, telephone number, IP address and mail address, mail text length and packet size, and media classification, etc.

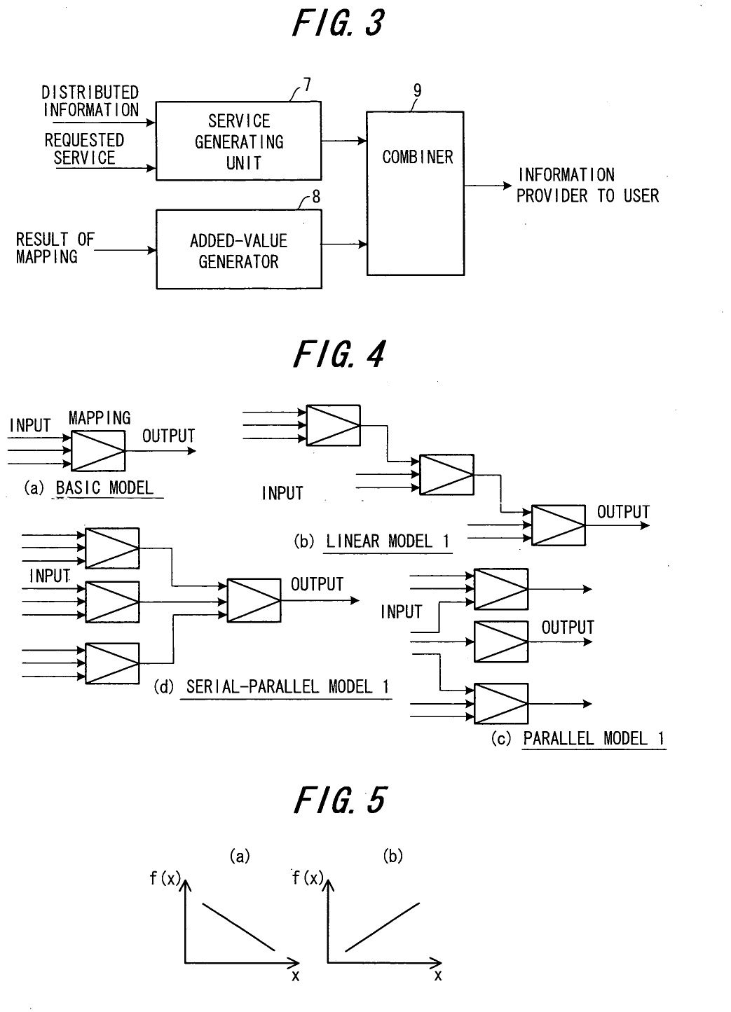

The arrangement of FIG. 2 modifies information, which is provided to a user, based upon the result of mapping, thereby changing the value of the information, and then provides the information to the user. As a result, value similar to a kind of “surprise” or “changeability” is added to the communication service. FIG. 3 is a block diagram illustrating the principal part of another information providing server system for implementing the flow of FIG. 1. By providing the user with information (content) upon furnishing it with added value, value similar to a kind of “surprise” or “changeability” is added to the communication service.

A service generating unit 7 that generates a service for a user outputs content, which conforms to a service requested by the user, from multiple items of content provided by an information provider, an added-value generator 8 generates added-value information, which is applied to content, based upon the result of mapping, and a combiner 9 applies the added value, which is output from the added-value generator 8, to the content output from the service generating unit 7, and transmits the resulting content as information provided for the user. As a result, content can be sent to the user upon adding new value such as musical information.

(b) Mapping Function

Mapping functions include linear, non-linear and random functions, etc., and they are used selectively as necessary. These functions may also be combined. As for the combining method, basic models of mapping for creating value are combined and various combinations are applied in accordance with the particular objective, these combinations being of “serial type”, “parallel type” and “serial-parallel-type”. Conceptual images of these combinations are illustrated at (a) to (d) in FIG. 4.

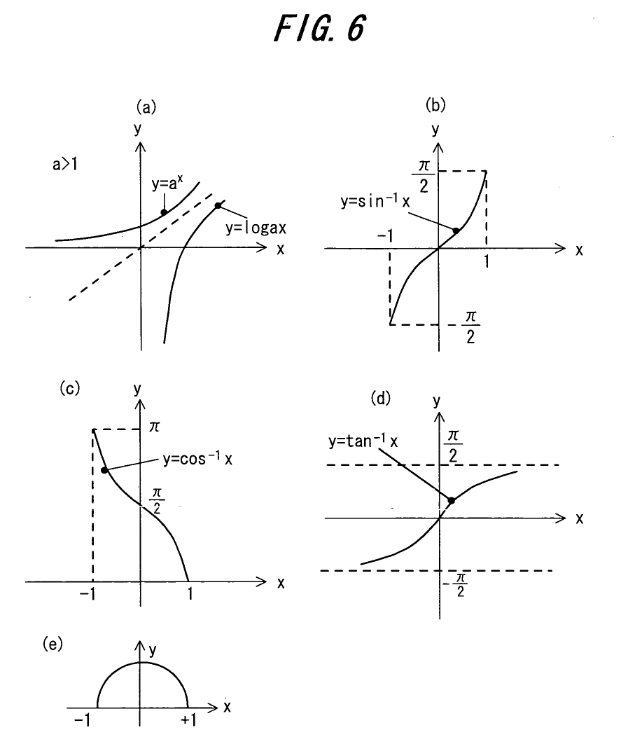

In linear mapping, value to be provided is defined by a relationship decided by a linear function f(x)=ax+b. Graphs of these functions are illustrated at (a) and (b) in FIG. 5. Non-linear mapping defines provided value by an n-th dimensional function
f(x)=axⁿ+bx⁽ⁿ⁻¹⁾+cx⁽ⁿ⁻²⁾+ . . .
or by a logistics mapping
f(x)=ax(1−x)
Other functions included are a logarithmic function (y=a^{x}) and inverse function (y=log ax) is logarithmic function, trigonometric functions (y=sin x, y=cos x) and the inverse triangular functions (y=sin⁻¹x, y=cos⁻¹x, y=tan⁻¹x, y=cot⁻¹x, y=sec⁻¹x, y=cosec⁻¹x), etc. Also included are a fractional function such as y=1/(x−a), an irrational function such as y=(1−x²), a hyperbolic function such as sinhx=(e^{x}+e^{-x})/2, and an inverse hyperbolic function such as cothx=(e^{x}+e⁻)/(e^{x}−e^{-x}). Graphs of these functions are illustrated at (a) to (e) in FIG. 6. A random function regards input information as information that is “plaintext” and defines the provided value by cryptography algorithm such as an RSA scheme, elliptic (discrete logarithm) scheme or hash function.

Example of Linear Mapping

An example in which the mapping function is linear (y=ax+b) will now be described.

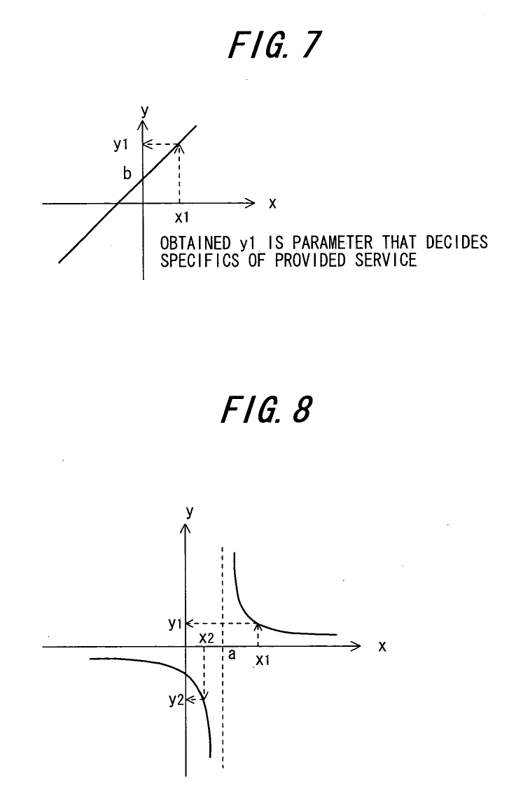

Travel displacement (moving speed, etc.) of the user of input information is applied to the linear function “y=ax+b” as “x”, and from this function, a value is calculated as an identifier of content access or as a parameter that identifies content in the possession of an information provider such as a game provider. FIG. 7 illustrates a graph of this linear mapping function.

Example of Non-Linear Mapping

An example in which the mapping function is a fractional function of a non-linear function [y=1/(x−a)] will now be described.

In a case where the input information is the position of the user terminal, a value obtained by quantizing latitude and longitude information is applied to the fractional function y=1/(x−a) as “x”. A map code (x1 or x2), etc., is generated from the position (latitude: yy.yy, longitude: zz.zz) of the mobile information terminal of the user, the generated map code (x1 or x2) is applied to the fractional function y=1/(x−a), and a value is calculated as an identifier of content access or as a parameter that identifies content in the possession of an information provider or game provider. The non-linear mapping applied differs owing to the means for implementing value provided according to the service and, in the present invention, includes the combining or repeating of a plurality of non-linear mappings. FIG. 8 illustrates a graph of this non-linear mapping function.

Example of Non-Linear Mapping . . . [One-Way Function MD5 (Message Digest 5)]

An example in which the mapping function is a one-way function will now be described. It should be noted that MD5 maps input data to a 128-bit hash value.

In a case where the input information is the telephone number (xxx-xxxx-xxxx) of the mobile information terminal of the user, a hash value that has been generated by the unidirectional function MD5 is assumed to be “95 04 F7 B0 70 3A 1F 5E AB 26 69 76 28 05 2F 4C(HEX)”. A stipulation such as the first digit “95” or the final digit “4C” or an nth (e.g., the fourth digit from the first) digit “B0” is applied and a value is calculated as an identifier of content access or as a parameter that identifies content. In this case, the specific method of validating the hash value as the identifier differs owing to the means for implementing the respective value. This is a case where the one-way function MD5 has been applied. However, the present invention is capable of being implemented using the Internet standard algorithm MD4 or SHAL and includes joint use of other cryptography techniques (e.g., private key/public key cryptosystem or one-time-password, etc.).

### (C) Second Embodiment

(a) Configuration of Network System

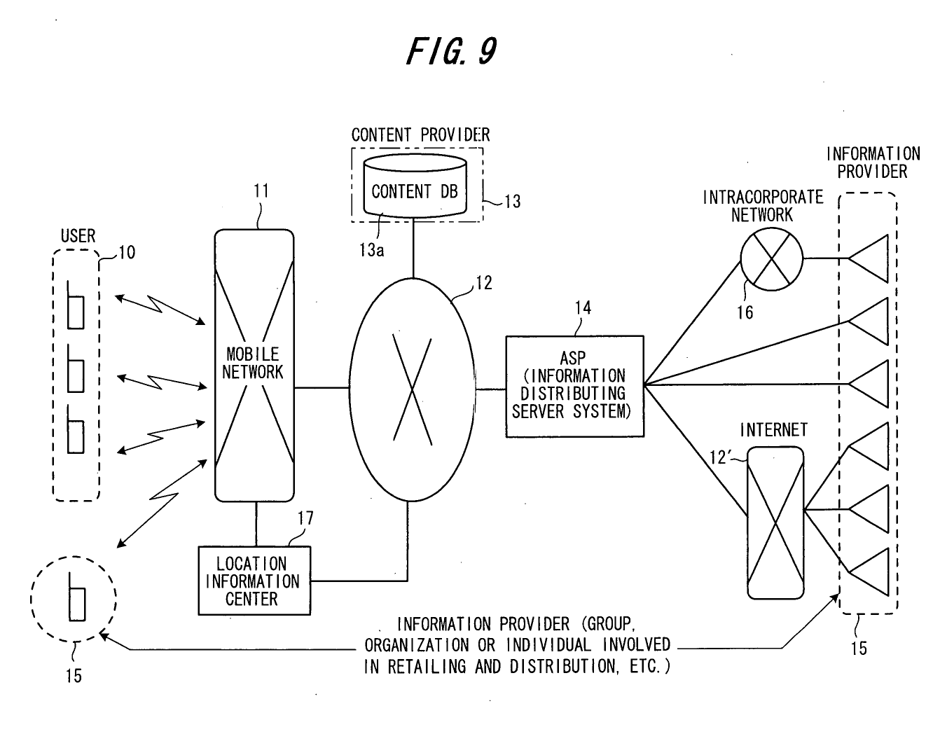

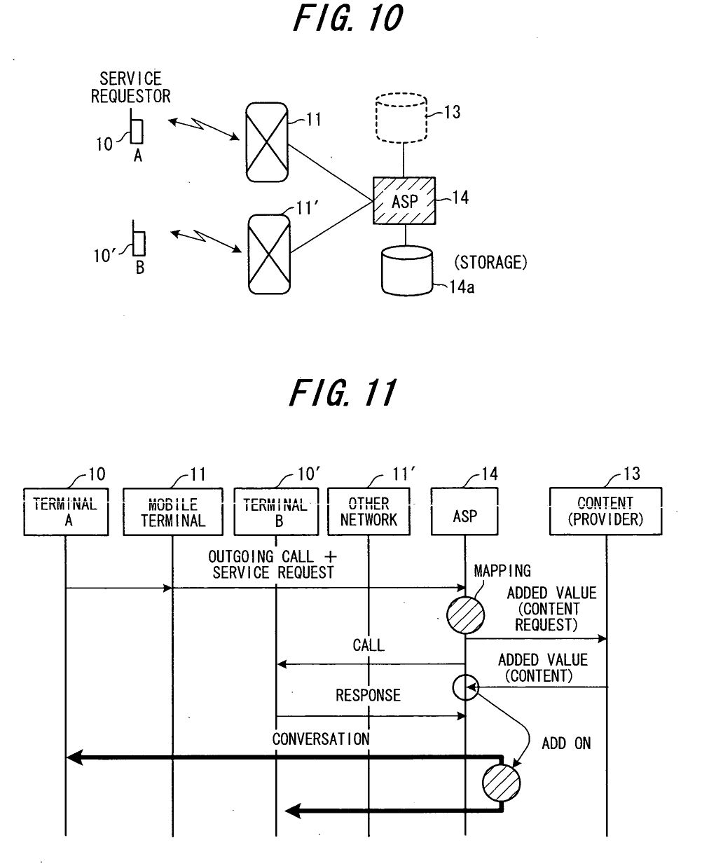

FIG. 9 illustrates an example of the configuration of a network system to which the present invention is applied. In this network system, an information distributing server system maps “formal meaning”, which is expressed by various information obtained from a mobile information terminal and from the mobile communication environment, creates a kind of “uncertainty” in the communication service by in deterministically changing, or changing the quality of, informational content, which is provided or distributed by the information provider, based upon the result of mapping, and provides the communication service with elements that give the user a sense of “surprise” or “changeability”, which cannot be predicted by the service user. Here “in deterministic” means “cannot be decided”, “cannot be predicted” and “unexpected”. The information provider is a group, organization or individual involved in retailing, distribution, a game software enterprise or an event organizing enterprise.

In FIG. 9, a mobile information terminal (user) 10 such as a mobile telephone or PDA possesses a voice communication and data communication function in a public mobile communication network 11 and is equipped with the functions of an Internet connection terminal (WWW access, display and voice signal generation inclusive of data such as text, still pictures, moving pictures, voice and music, and an e-mail sending/receiving function). The public mobile communication network 11 is connected when the mobile information terminal 10 performs communication. In a case where the mobile information terminal sends and receives data to and from the Internet, the public mobile communication network 11 has function for relaying data in the network.

Internet 12 is the usual Internet and transfers packet data using TCP/IP. When the mobile information terminal 10 or terminal possessed by the information provider has been connected to the Internet 12, it becomes possible to send and receive information to and from various servers or to and from other terminals.

A service provider (content provider) 13 is constituted by a server or the like operated and administered by an ordinary ISP (Internet Service Provider). The provider 13 has a content database 13a that provides a subscriber with necessary content as by a web service (HTTP) or e-mail service (SMTP, POP), etc.

An information distributing server system (ASP: Application Service Provider) 14 distributes necessary information to a plurality of individuals located in a specific wireless area, namely to users of the mobile information terminal 10. The information distributing server system 14 has a database constituted by distributed information from an information provider 15, user registration information based upon the ideas of the terminal users, and present-location information from the mobile information terminal 10 connectable to the Internet.

Using a function for providing various Internet services and various processing functions for implementing this function, the information distributing server system 14 provides an appropriate service to each user of the mobile information terminal 10 who gains access via the Internet 12 and public mobile communication network 11. In the description that follows, the information distributing server system 14 and its operator are treated as a whole, and the mobile information terminal 10 and its user are treated as a whole.

The information provider 15 is intended to distribute information to the service user who possesses the mobile information terminal. The information provider 15 is an enterprise, group or individual that relies upon the information distributing server system 14 to distribute information. The information provider 15 has an information processing function and information input terminal (e.g., a personal computer) necessary for the connection to the information distributing server system 14 and makes the connection to the information distributing server system 14 via an intracorporate intranet 16 and not just Internet 12′ and public mobile communication network 11.

A location information generating and transfer function unit 17 has a function, which is for generating and transferring location information of the mobile information terminal 10, as a function solely of the mobile information terminal or as a function of the public mobile communication network. An example of the unit 17 is location information center. The location information is information for specifying position with enough accuracy to provide service. An example of this information is data such as longitude and latitude.

(b) Basic Processing Configuration of the Present Invention

(b-1) Configuration in Which the Information Distributing Server System Provides Added Value on its Own (Basic Processing Configuration 1)

FIG. 10 is a basic processing configuration in which the information distributing server system (which will also be referred to simply as an ASP below) 14 provides added value on its own. This is a configuration in which added value is applied to the content of communication in response to a request from the calling party.

The information distributing server system (ASP) 14 furnishes the content of communication with added value in response to a request from a calling party A. For example, in a case where image mail is transmitted, background music is selected from location information, outgoing-call time and telephone number of calling party A and the mail address of the called party, and the background music is attached to the image mail.

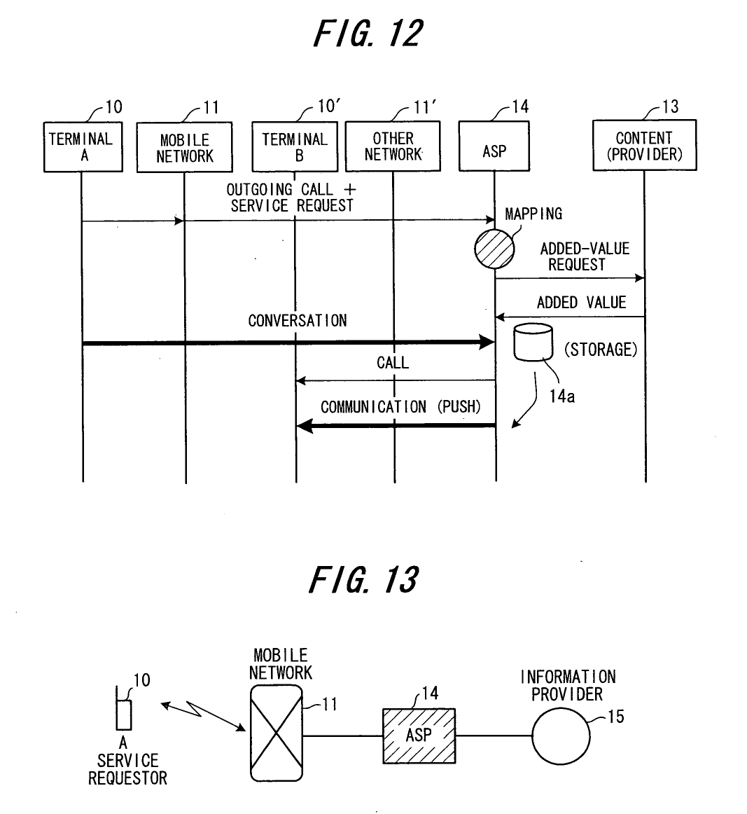

There are online and offline methods for implementing this form of service. FIG. 11 is a sequence diagram of an online method. Here the information distributing server system 14 calls the other party (terminal B) in response to a request from the calling party (terminal A) and, at the same time, maps input information, acquires added value (content), which conforms to the result of mapping, by so requesting a content provider 13, and adds on the acquired content in real time during the two-party call. FIG. 12 is a sequence diagram of an offline method. In a service that does not require quick response (e.g., communication of mail from terminal A), the information distributing server system 14 maps input information, acquires added value (content), which conforms to the result of mapping, from the content provider 13, adds this content to image mail, stores the result in storage 14a and adds on the result when image-mail information is provided to the communicating party.

(b-2) Configuration in Which the ASP Provides Added Value by Cooperating with the Information Provider (Basic Processing Configuration 2)

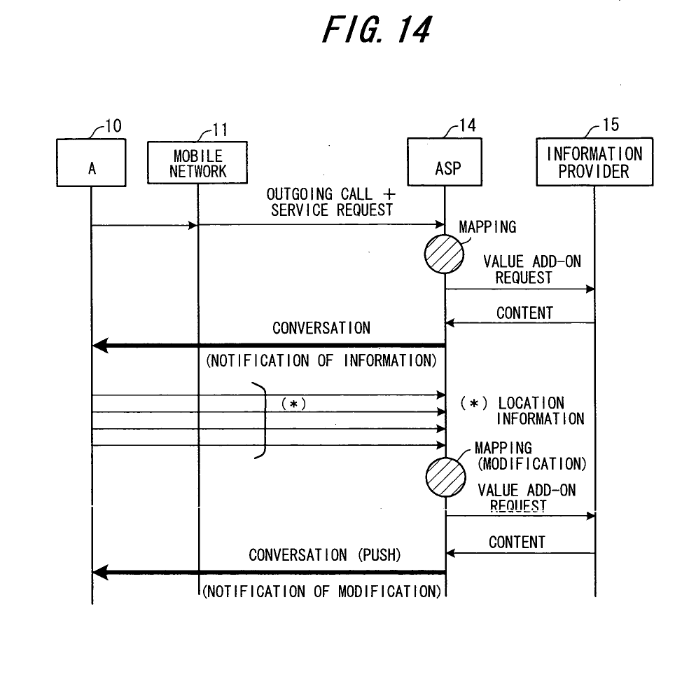

FIG. 13 illustrates a basic processing configuration in which the information distributing server system (ASP) 14 provides added value in association (cooperation) with the information provider 15, and FIG. 14 is a sequence diagram. This is a case where the content of game software is modified by cooperation with an information provider (game software provider).

The information distributing server system (ASP) 14 maps input information (e.g., location information) in response to a service request (request for game software) from a service requestor (user) A and reports the result of mapping to the information provider 15 (i.e., requests that value be added). The information provider 15 adds a modification (individuals who appear in the game and the time limit of the game), which conforms to the result of mapping, to the information (game software) provided, and the information distributing server system 14 provides the user A with the information (game software) to which value has been added. More specifically, the information distributing server system 14 modifies the specifics of content based upon various information concerning the calling party in response to a request from the calling party (terminal A) and provides the content to the calling party.

The above-described sequence processing is thenceforth executed based upon information entered by the user, namely the location information.

(b-3) Configuration in which the ASP Provides Added Value Relating to Distribution/Advertisement Service of an Information Provider (Basic Processing Configuration 3)

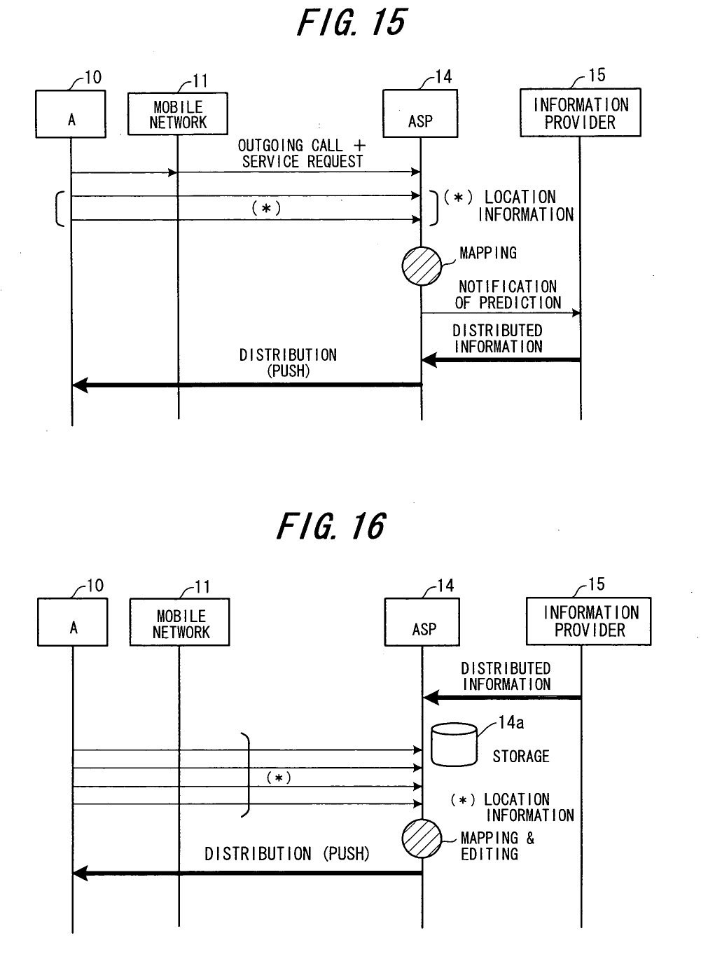

FIGS. 15 and 16 are sequence diagrams of basic processing configurations in which the information distributing server system (ASP) 14 provides an information provider with added value relating to an advertising service distributed by the information provider.

In the example of FIG. 15, the information distributing server system 14, in accordance with the status of the user (terminal A), e.g., the result of mapping applied to the user location information, notifies the information provider 15 of a distribution mode and method whereby distribution of information can be performed effectively, and the information provider 15 refers to this notification, generates distributed information and requests the information distributing server system 14 to perform distribution.

In the example of FIG. 16, the information distributing server system 14 accepts distribution information from the information provider 15 in advance and stores it in storage 14a. In such case the information distributing server system 14 extracts distribution information that will enhance distribution effectiveness in accordance with the status of the user (terminal A), edits the information and distributes it.

(c) Processing by ASP

(c-1) Processing for Registering Service User

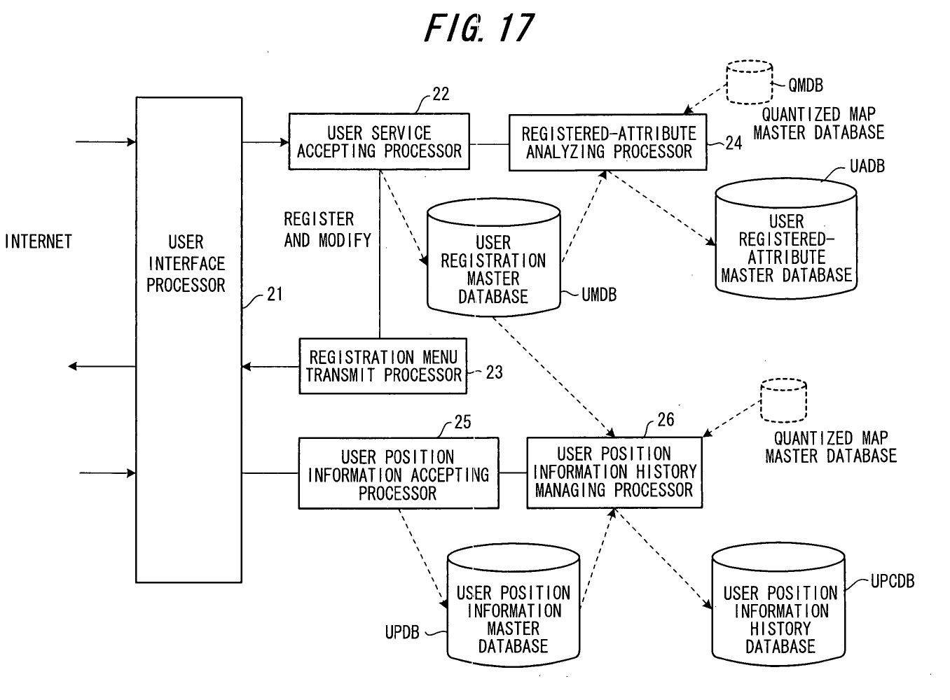

In the information distributing server system 14, a user interface processor 21 sends and receives information to and from the mobile information terminal 10 via the Internet 12 and delivers receive data to a corresponding processor in accordance with the content of data received, as shown in FIG. 17.

A user service accepting processor 22 accepts requests from the mobile information terminal 10 to register a service anew, modify the service, start, temporarily stop and cancel the service, and causes a registration menu screen to be displayed on the display of the mobile information terminal 10 via a registration menu transmit processor 23. Further, the user service accepting processor 22 stores the result of processing conforming to the type of each request in a user registration master database UMDB as new registration data or updates the present registration data based upon the new registration data.

In case of new registration, the user service accepting processor 22 acquires an area for the user in a user position information master database UPDB. A registered-attribute analyzing processor 24 classifies users attribute by attribute based upon the data in the registration master database UMDB and stores the result in a user registered-attribute master database UADB. The registered attribute of a user is for classifying and identifying information desired for distribution or content desired to be utilized (e.g., music, video, game software, etc.). Attributes are gender, age and field of interests (category). The registered-attribute analyzing processor 24 refers to quantized maps in a quantized-map master database QMDB.

(c-2) Processing for Registering Position

In response to the start of service, a user position information accepting processor 25 periodically accepts location information from the mobile information terminal 10 and stores this information in a registered user position information master database UPDB. A user position information history managing processor 26 stores a history of location information for each user in a user position information history database UPCDB.

More specifically, the user location information accepting processor 25 receives location information of an applicable user from the mobile information terminal 10 of the service user or generated by the corresponding location information center 17 and sent to the server system (ASP) 14 autonomously from time to time or sent in response to a command from the server system, and stores this location information in a database together with related information such as time. Further, the user location information accepting processor 25 stores the zone of residence so as to facilitate the calculation of data representing the distribution state, calculates the moving speed per unit time, the direction of movement and the moving distance, classifies and processes this information appropriately and stores the results in a database.

(c-3) Processing for Registering Information Provider

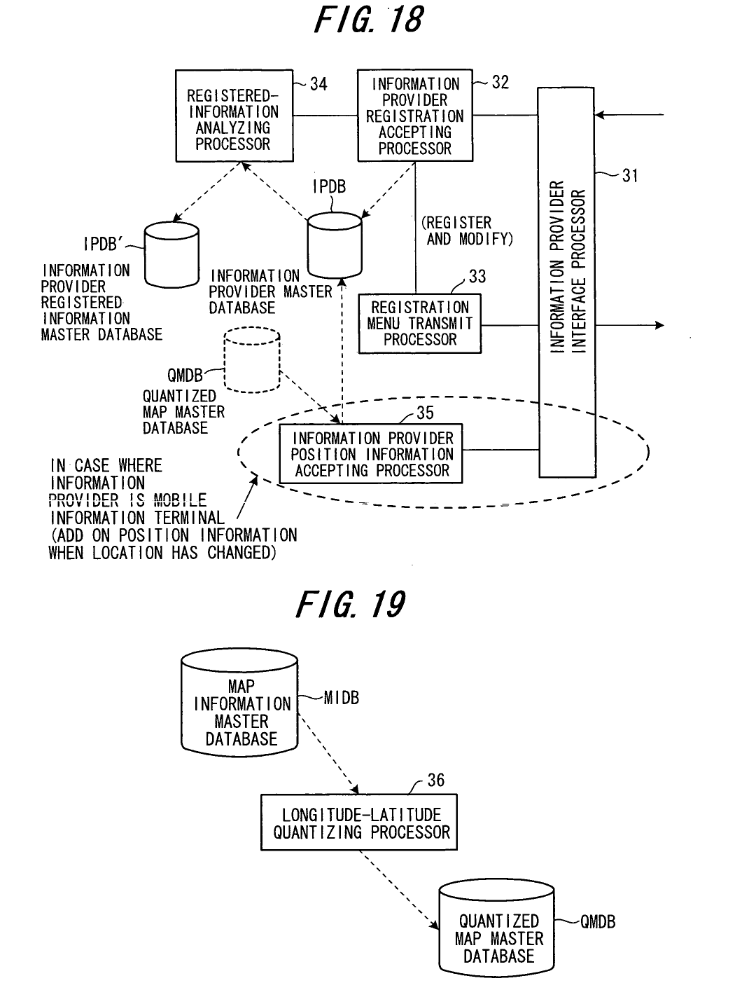

In the information distributing server system 14, as shown in FIG. 18, an information provider interface processor 31 sends and receives information to and from the information provider 15 and delivers received data to a corresponding processor in dependence upon the content of the received data. An information provider registration accepting processor 32 accepts “REGISTER”, “CHANGE”, “PAUSE”, “START”, “CANCEL”, etc., as a distribution request from the information provider 15 and stores the requested registration content in an information provider master database IPDB. If “REGISTER” has been requested or if a “CHANGE” in distribution conditions or content has been requested, a registration menu transmit processor 33 transmits a registration menu screen to the information provider 15.

A registered-information analyzing processor 34 classifies distribution information, which has been stored in the information provider master database IPDB, according to condition and stores the information in an information provider registered information master database IPDB′. Content registered by the information provider is location, distribution information and distribution conditions (distribution target and frequency, etc.) and the like.

If, in a case where the information provider 15 is a portable terminal, an information provider location information accepting processor 35 receives the position of the information provider 15, the position information of the information provider that has been stored in the information provider master database IPDB is updated.

(c-4) Quantizing Processing for Map Information

FIG. 19 is a diagram useful in describing processing for quantizing map information.

Information concerning various maps is digitized and the digital map information obtained is stored in a map information master database MIDB. A longitude-latitude quantizing processor 36 quantizes longitude and latitude of the digital map information and stores the result in the quantized-map master database QMDB as geographical information used in the service. The basic zone size also is defined at the same time.

(c-5) Process for Deciding Designated Zones Classified by Information Provider.

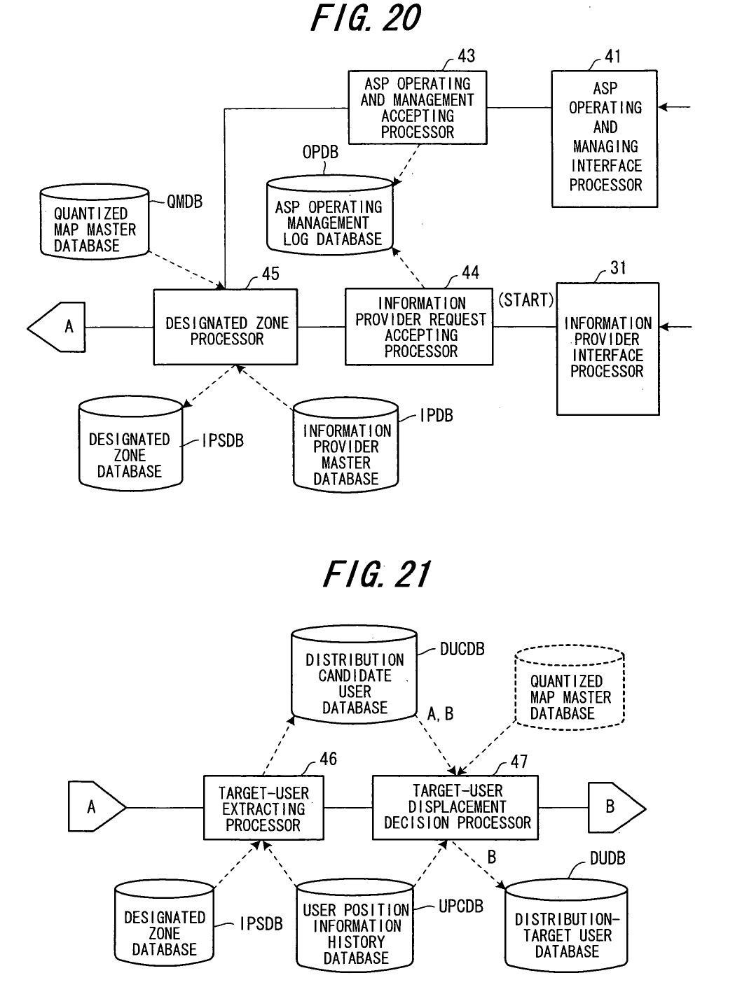

FIG. 20 is a diagram useful in describing the information distributing server system 14 that implements a process for deciding designated zones classified by information provider.

If the ASP operating and managing interface processor 41 and information provider interface processor 31 received a command from the ASP operator or a service start request from the information provider 15 is accepted, respectively, these deliver the command or request to an ASP operating and management accepting processor 43 and information provider request accepting processor 44, respectively.

The ASP operating and management accepting processor 43 and the information provider request accepting processor 44 accept a command or request, log the content of the command or request in the operating management log database OPDB and request a designated zone processor 45 to decide a designated zone classified by information provider. Using the information provider master database IPDB and quantized-map master database QMDB, the designated zone processor 45 obtains a zone designated by the information provider and stores the result in a designated zone database IPSDB in which designated zones are classified by information provider.

(c-6) Process for Deciding User Who is to be the Object of Information Distribution

FIG. 21 is a diagram useful in describing the information distributing server system 14 that implements a process for deciding a user who is to be the object of information distribution.

A target-user extracting processor 46 obtains a user who is to be a candidate for distribution of information based upon the designated zone database IPSDB and a user position information history database UPCDB and stores the result in a distribution candidate user database DUCDB. Next, using the distribution candidate user database DUCDB and user position information history database UPCDB, a target-user displacement decision processor 47 narrows down users, who are to be distributed information, by locational displacement (movement displacement) of the user, and stores the result in a distribution-target user database DUDB.

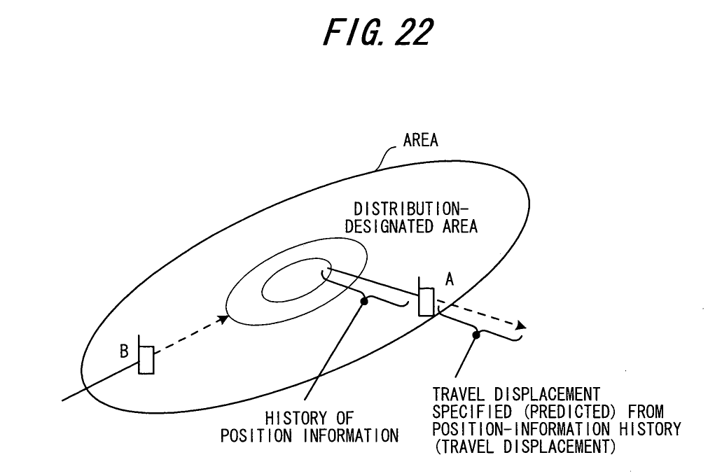

FIG. 22 is a diagram useful in describing processing for narrowing down users who are to be distributed information. Here AREA represents a zone that has been designated by an information provider. Users A and B presently are in this zone. Based upon the user position information history database UPCDB, it is predicted that user A will leave the zone AREA at the time of information distribution and it is decided that only user B will be a candidate for distribution of information.

Thus, a user that is presumed to be present in the zone desired for distribution of information by the information provider 15 is stored in the distribution-target user database DUDB.

(c-7) Information Distribution Processing

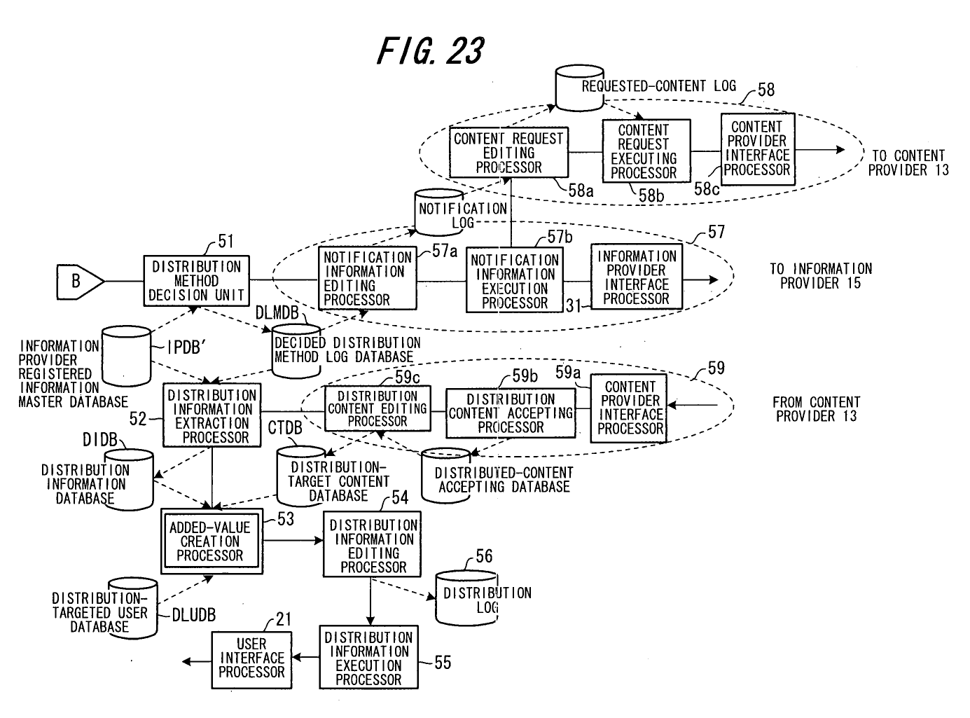

FIG. 23 is a diagram useful in describing the information distributing server system 14 that implements information distribution.

If creation of the distribution-target user database DUDB has been completed, a distribution method decision unit 51 decides one or more distribution methods of high advertising effectiveness based upon distribution conditions specified (desired) information providers organized in the information provider registered information master database IPDB′, and stores the result in a decided distribution method log database DLMDB. In a case where the information provider 15 has completed registering distribution information in advance, a distribution information extraction processor 52 extracts distribution information that has been stored in the information provider registered information master database IPDB′, coordinates this information with the decided distribution method and stores the result in a distribution information database DIDB′ in which distribution information is stored according to distribution method. Next, an added-value creation processor 53 creates added value using a distribution-target content database CTDB and inputs distribution information corresponding to the distribution method decided, users who are to be distributed this information and the above-mentioned added value to a distribution information editing processor 54. The latter edits the distribution information, distributes the relevant information to the individual users via a distribution information execution processor 55 and the user interface processor 21 and simultaneously records this in a distribution log 56.

If the distribution method decision unit 51 has not accepted a message distributed from the information provider 15 in advance, then the processor 51 notifies the information provider 15 of the fact that an effective distribution method has been decided, this notification being given via a block 57 (notification information editing processor 57a, notification information execution processor 57b and information provider interface processor 31). The information provider 15 decides and inputs distributed information. The distributed information is stored in the information provider registered information master database IPDB′, after which similar processing is executed. In this case, the content provider 13 can also be requested for distribution information suited to the decided distribution method via a block 58 (content request editing processor 58a, content request execution processor 58b and content provider interface processor 58c). The distributed information from the content provider 13 is stored in the distribution-target content database CTDB via a block 59 (content provider interface processor 59a, distribution content accepting processor 59b and distribution content editing processor 59c). The added-value creation processor 53 creates added value by using this distribution-target content database CTDB. Processing similar to the above is thenceforth executed.

(c-8) Processing for Gathering User Reaction to Distributed Information

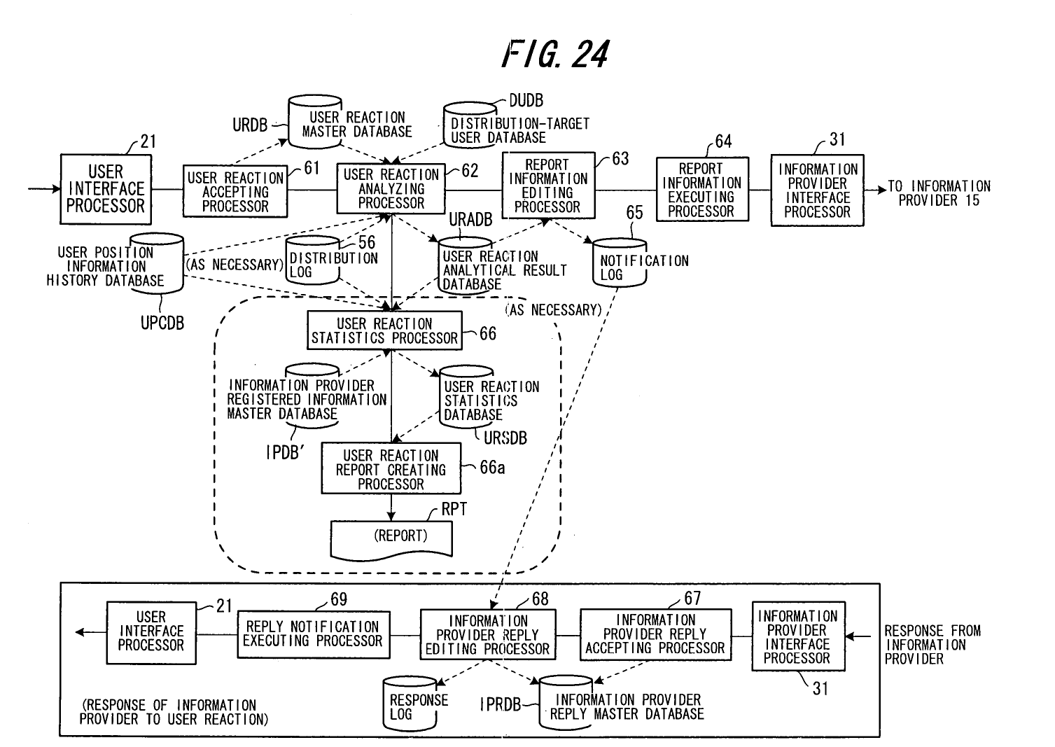

FIG. 24 is a diagram useful in describing the information distributing server system 14 for gathering user reaction to distributed information. User reaction (response) referred to here is response to a questionnaire, the making of a reservation or an inquiry, which is included in the distributed information.

A user reaction accepting processor 61 of the information distributing server system 14 accepts a reaction to distributed information from a user 10 and records this reaction in a user reaction master database URDB. A user reaction analyzing processor 62 analyzes the reaction of the user by referring to the distribution-target user database DUDB, which is a record of the fact that information distribution has been carried out, the distribution log 56, the user position information history database UPCDB and the user reaction master database URDB, and stores the result in a user reaction analytical result database URADB. A report information editing processor 63 edits the content of the user reaction analytical result database URADB, reports this to the information provider 15 via a report information executing processor 64 and the information provider interface processor 31, and creates a notification log 65. It should be noted that a user reaction statistics processor 66 executes statistical processing relating to user reaction as necessary. More specifically, the user reaction statistics processor 66 executes statistical processing relating to user reaction based upon the distribution log 56, user position information history database UPCDB and user reaction analytical result database URADB and stores the result in a user reaction statistics database URSDB. A user reaction report creating processor 66a creates a user reaction report RPT using the user reaction statistics database URSDB. The report is sold to an information provider as necessary. That is, information obtained by statistical processing is a new source of income for the information distributing server system 14.

When the result of analysis of user reaction is received, e.g., when the user makes a reservation with regard to distributed information targeted on a sales reservation, the information provider 15 inputs confirmation (acceptance) of the reservation to the information distributing server system 14. An information provider reply accepting processor 67 stores a reply from the information provider 15 in an information provider reply master database IPRDB, and an information provider reply editing processor 68 refers to the notification log 65, reports the reply from the information provider to the user via a reply notification executing processor 69 and creates a reply log.

(c-9) Arrangement for Implementing Basic Processing Configuration 1

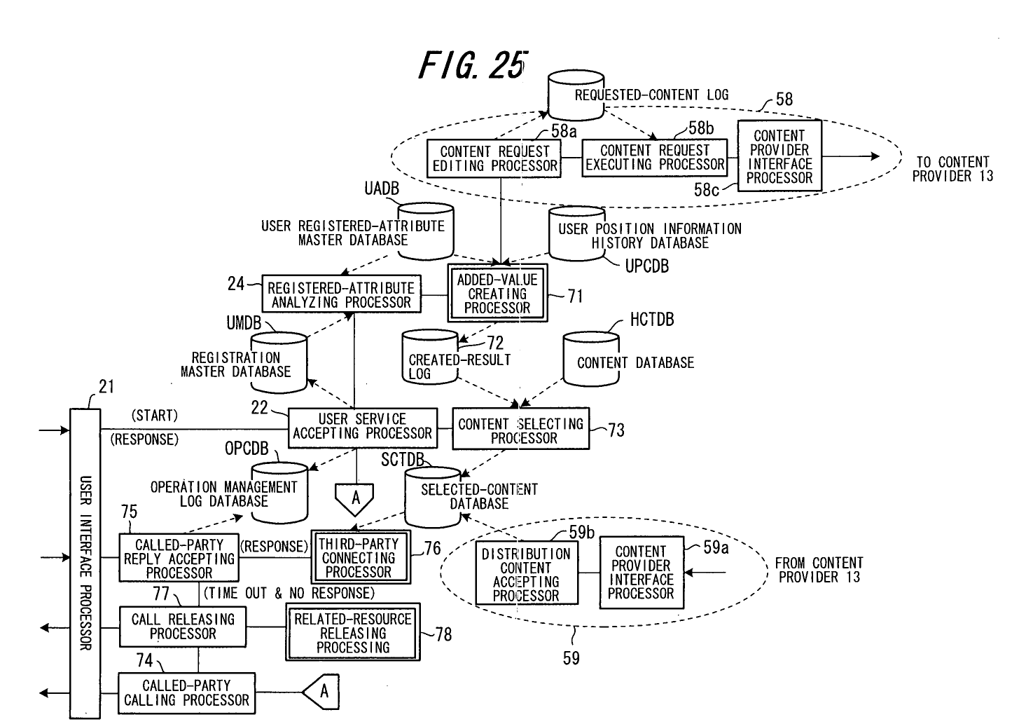

FIG. 25 is a diagram useful in describing implementation of basic processing configuration 1, in which the information distributing server system provides added value on its own.

In response to a service-start indication from a user (calling party), an added-value creating processor 71 creates added value based upon the user registered-attribute master database UADB, user position information history database UPCDB and correlation with the number of the other party, etc., and stores the result in a created-result log 72. A content selecting processor 73 selects content, which conforms to a service requested by the user, from a content group (a content database HCTDB in the possession of the ASP) possessed by the information distributing server system, applied added value to this content and stores the result in a selected-content database SCTDB. It should be noted that the operation of processors 21 to 24 has already been described in connection with FIG. 17.

At the same time that it receives indication of service start from a user, the user service accepting processor 22 places a call to the party communicating with the user via a called-party calling processor 74 and records this in an operation management log database OPCDB. Upon being notified from a called-party reply accepting processor 75 of the fact that there has been a reply from the communicating party, a third-party connecting processor 76 executes processing (third-party connecting processing) for providing the call with the selected content (inclusive of added value).

Upon accepting a service-end indication from the user, the called-party reply accepting processor 75 places only a record of this in the operation management log database OPCDB, a call releasing processor 77 releases the call, and a related-resource releasing processing 78 releases resources related to the call.

In a case where content requested by a user is not in the possession of the information distributing server system 14, the content provider 13 is requested for the applicable content via the block 58 in FIG. 25 (content request editing processor 58a, content request executing processor 58b and content provider interface processor 58c), and content received from the content provider 13 is stored in the selected-content database SCTDB via block 59 (content provider interface processor 59a and distribution content accepting processor 59b). Content can also be stored in the content database HCTDB possessed by the ASP.

(c-10) Arrangement for Implementing Basic Processing Configuration 2

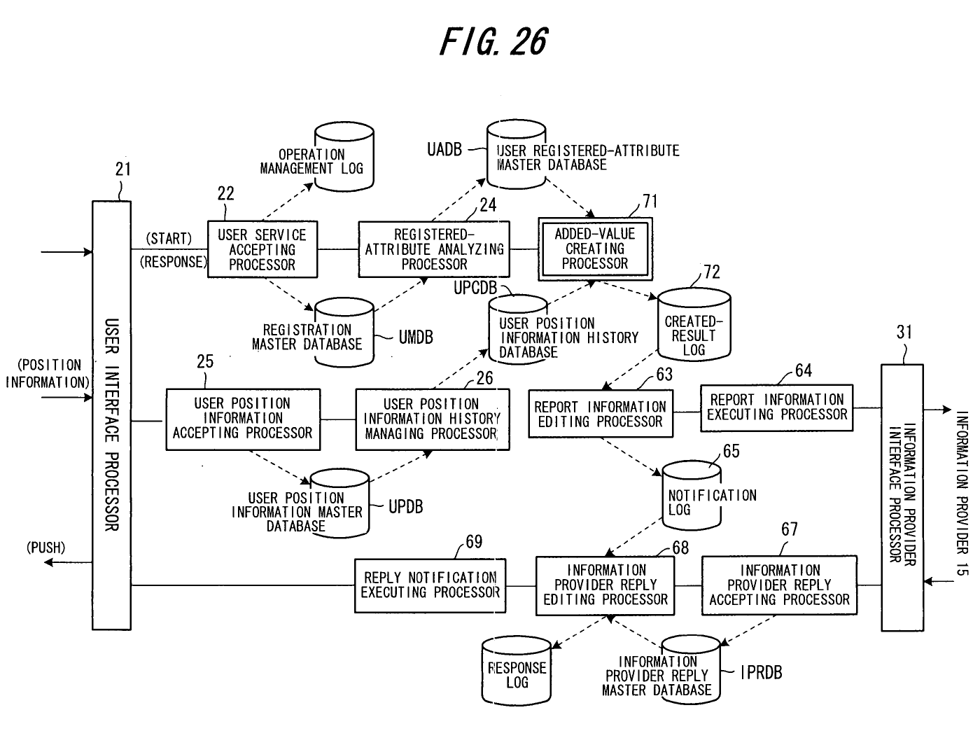

FIG. 26 is a diagram useful in describing implementation of basic processing configuration 2, in which the information distributing server system (ASP) provides added value in association (cooperation) with the information provider 15.

In response to a service-start indication from the user (calling party) 10, the added-value creating processor 71 creates added value based upon the user registered-attribute master database UADB, user position information history database UPCDB and correlation with the number of the other party, etc., and stores the created added value in the created-result log 72. The report information editing processor 63 reports the nature of the added value to the information provider 15 via the report information executing processor 64. On the basis of the notification, the information provider 15 selects and decides the content to be provided. The information provider reply accepting processor 67 stores the content selected and decided by the information provider 15 in the information provider reply master database IPRDB, and the information provider reply editing processor 68 refers to the notification log 65, reports the content from the information provider to the user via the reply notification executing processor 69 and creates a response log.

Upon accepting a service-end indication from the user, the user service accepting processor 22 places only a record of this in the operation management log database. It should be noted that the operation of processors 21 to 26 and that of processors 67 to 69 has already been described in connection with FIGS. 17 and 24, respectively.

(d) Settlement Sequence

(d-1) Settlement Sequence of Basic Processing Configuration 1

FIG. 27 illustrates a settlement sequence in case of implementation of basic processing configuration 1, in which the information distributing server system provides added value on its own.

A breakdown of a fee X for which the communications carrier charges a user is the total of a monthly communication fee (A), which includes a basic charge, and a service utilization fee (B). Here the service utilization fee (B) is composed of connection fee (B1) of the communications carrier and a service provision fee (B2) of the service provider [the information distributing server system (ASP)] (namely B=B1+B2). Therefore, the following holds:

$$\begin{matrix}X = A + B \\ = A + ( B1 + B2 )\end{matrix}$$

Accordingly, a financial institution BKC used by the communications carrier possessing a network bills a financial institution BKU of the user for the monthly user fee X (S1). The financial institution BKU of the user makes payment in accordance with the bill (S2). Next, the financial institution BKC of the communications carrier pays the service provision portion B2 (90% of B) of the information distributing server system (ASP) 14, which is included in the user payment X, to a financial institution BKA used by the ASP (S3). Further, the financial institution BKC of the communications carrier bills the financial institution BKA of the ASP for the connection agreement fee (S4). The financial institution BKA of the ASP makes payment in accordance with the bill (S5).

A financial institution BKI used by the information provider 15 bills the financial institution BKA of the ASP for the information provision fee as necessary (S6). The financial institution BKA of the ASP makes payment in accordance with the bill (S7).

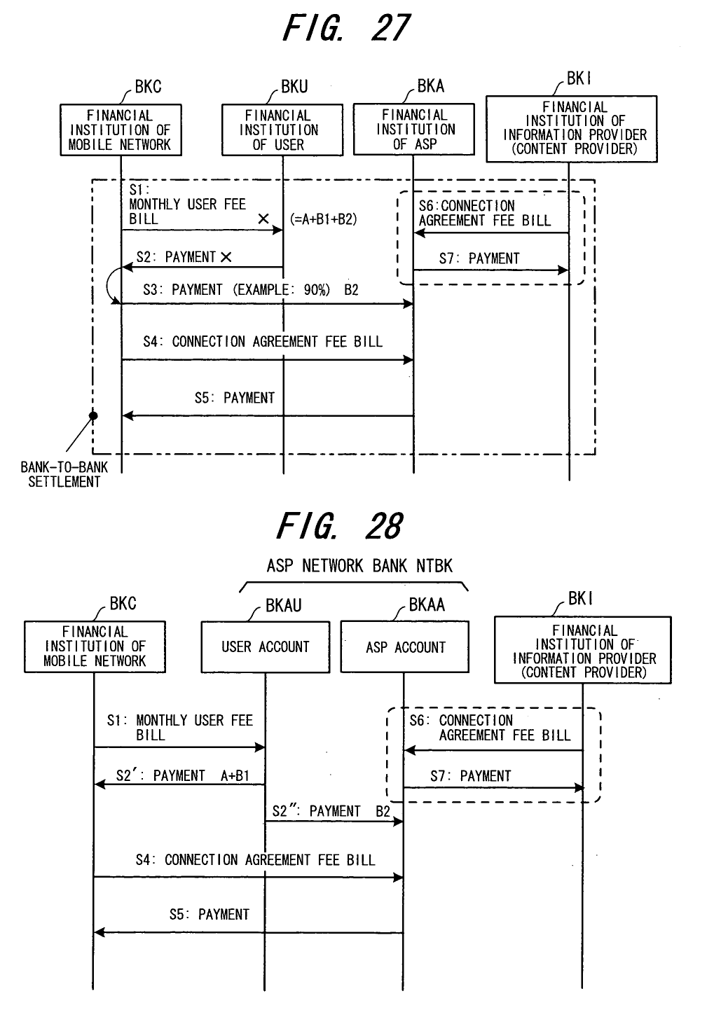

The foregoing is a case where the ASP does not also engage in a network banking business. However, in a case where the ASP engages in a network banking business as well and the user has an account with the network bank, the settlement processing at S3 in FIG. 27 can be omitted. More specifically, as shown in FIG. 28, an ASP network bank NTBK executes processing (S2′) for making payment of A+B1, from which the service provision fee (B2) has been subtracted, to the financial institution BKC of the communications carrier and executes processing (S2″) for remitting the service provision fee B2 from a user account BKAU to an ASP account BKAA, thereby making it possible to omit the bank-to-bank settlement processing at S3 in FIG. 27. As a result, it becomes possible to reduce settlement commissions and, hence, the ASP can provide the user with the advantage of a discounted utilization fee.

(d-2) Settlement Sequence of Basic Processing Configuration 2

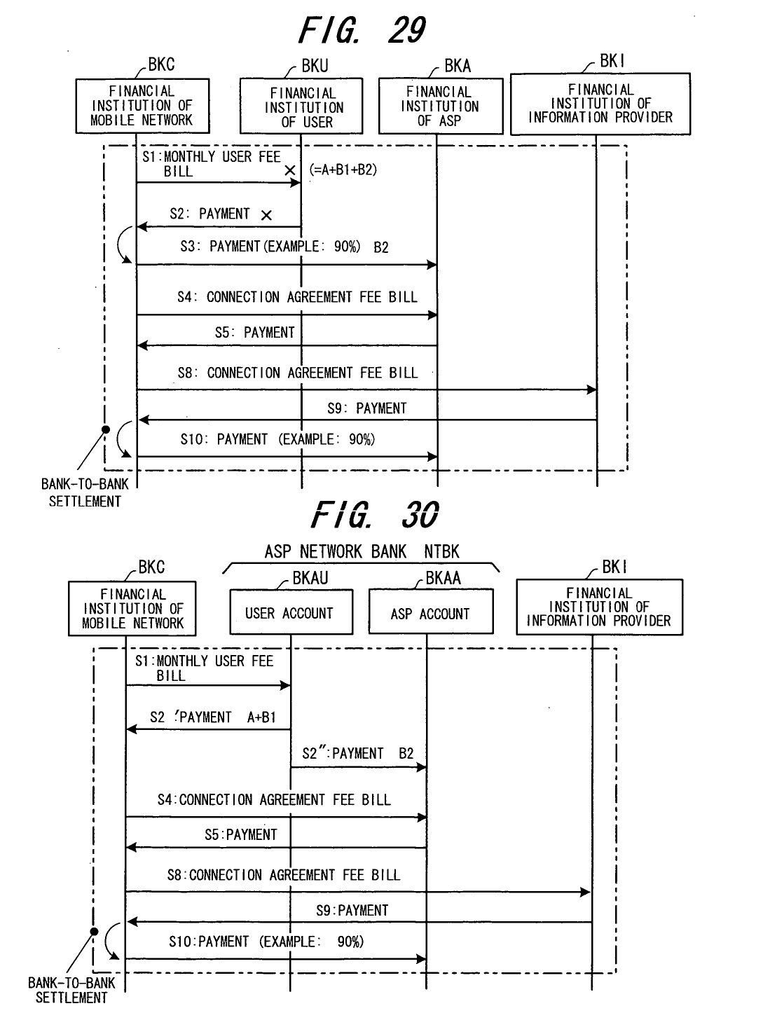

FIG. 29 illustrates a settlement sequence in case of implementation of basic processing configuration 2, in which the information distributing server system (ASP) provides added value in association (cooperation) with the information provider 15. In the case of this sequence, the location of the information provider is not fixed, i.e., the location provider is utilizing a mobile information terminal. This sequence differs from that of FIG. 27 in that the financial institution BKC of the communications carrier bills the financial institution BKI of the information provider 15 for the connection fee (S8), the financial institution BKI of the information provider makes payment in accordance with the bill (S9), and the communications carrier pays the ASP part of the payment received from the information provider (S10).

In a case where the ASP engages in network banking as well and the user has an account with network bank, as shown in FIG. 30, the bank-to-bank settlement processing at S3 in FIG. 29 can be omitted. As a result, the ASP can provide the user with the advantage of a discounted utilization fee.

(d-3) Settlement Sequence of Basic Processing Configuration 3

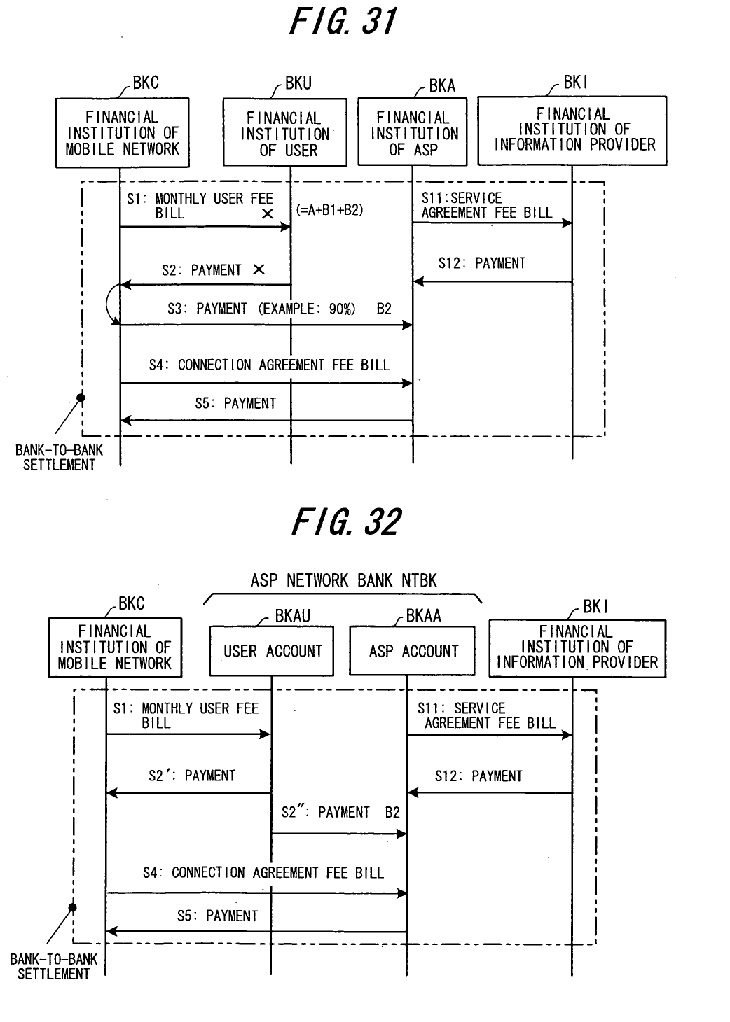

FIG. 31 illustrates a settlement sequence in case of implementation of basic processing configuration 3, in which the information distributing server system (ASP) provides the information provider with added value relating to a distribution and advertisement service afforded by the information provider.

The sequence of FIG. 31 differs from that of FIG. 27 in that the financial institution BKA of the information distributing server system (ASP) bills the financial institution BKI of the information provider for a fee (service agreement fee) regarding an added-value provision service (S11), and the financial institution BKI makes payment to the financial institution BKA (S12).

In a case where the ASP engages in network banking as well and the user has an account with network bank, as shown in FIG. 32, the bank-to-bank settlement processing at S3 in FIG. 31 can be omitted. As a result, the ASP can provide the user with the advantage of a discounted utilization fee.

(e) Settlement Processing by ASP

(e-1) Processing Block

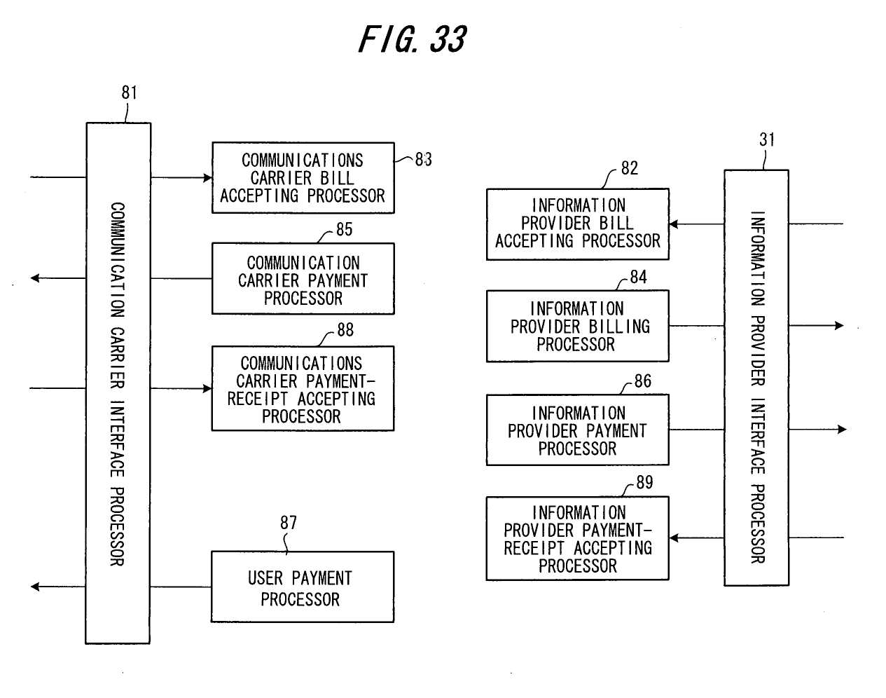

FIG. 33 is a block diagram of settlement processing executed by an ASP. FIG. 33 illustrates only the processors relating to the information provider and communications carrier; the ASP operation management interface processor and the processing block relating to operation and management of the settlement process in the ASP are deleted.

The settlement processing block includes (1) interface processors 31, 81 for interfacing an information provider or content provider such as a game provider and a communications carrier such as a mobile network carrier or an APS operation administrator, etc., (2) bill accepting processors 82, 83 for accepting bills for utilization fees, which are directed to the user of the service, from the information provider or content provider and communications carrier, (3) a billing processor 84 for billing the information provider and content provider for a fee relating to utilization of the service, (4) payment processors 85 to 87 for processing payment to the information provider or content provider, communications carrier and user of the service, and (5) payment-receipt accepting processors 88, 89 for executing payment-receipt processing relating to utilization of the service from the information provider or content provider, communications carrier and user of the service.

The user payment processor 87 is necessary in a case where the ASP also engages in network banking and the user of this service has opened an account with the network bank of the ASP.

(e-2) Processing in a Case where ASP makes Payment to Communications Carrier in Response to Billing from Communications Carrier

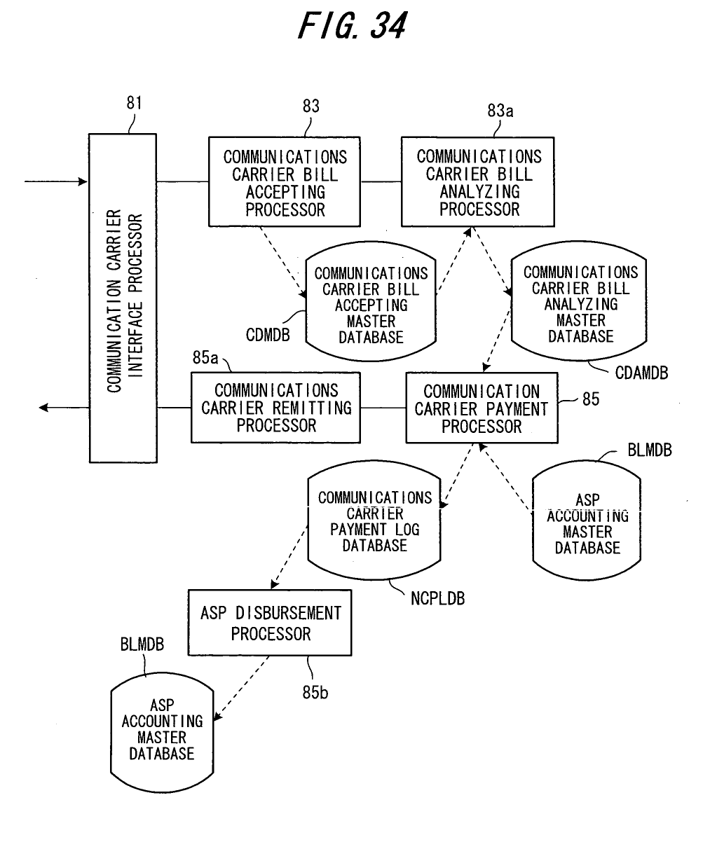

FIG. 34 is a diagram useful in describing processing in a case where, at implementation of service, an ASP makes payment of a connection agreement fee to a communications carrier in response to billing by the communications carrier.

The communications carrier bill accepting processor 83 accepts billing from the communications carrier and stores the details thereof in a communications carrier bill accepting master database CDMDB. Next, a communications carrier bill analyzing processor 83a analyzes the details of the bill from the communications carrier and stores the result in a communications carrier bill analyzing master database CDAMDB. If the result of analysis is that the bill from the communications carrier is one relating to a connection agreement with regard to the ASP, then the communications carrier payment processor 85 executes the required payment procedure based upon an ASP accounting master database BLMDB, records the result in a communications carrier payment log database NCPLDB and, at the same time, a communications carrier remitting processor 85a executes processing for making a remittance to the financial institution used by the communications carrier.

An ASP disbursement processor 85b executes accounting disbursement processing based upon the communications carrier payment log database NCPLDB and causes the result to be reflected in the ASP accounting master database BLMDB.

(e-3) Processing in a Case where User makes Payment in Response to Billing from Communications Carrier

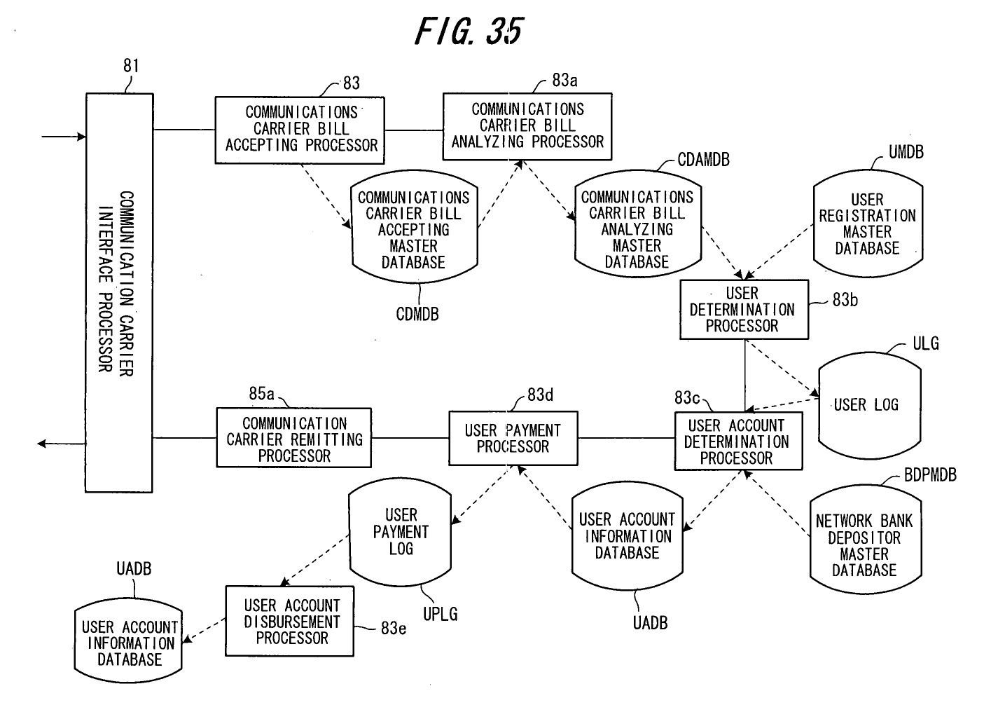

FIG. 35 is a diagram useful in describing processing in a case where a user makes payment of a monthly fee to a communications carrier in response to billing by the communications carrier. Here it is assumed the ASP also engages in network banking and that the user of the service has opened an account.

The bill from the communications carrier is accepted and the communications carrier bill accepting processor 83 stores the details thereof in the communications carrier bill accepting master database CDMDB. Next, the communications carrier bill analyzing processor 83a analyzes the details of the bill from the communications carrier and stores the result in the communications carrier bill analyzing master database CDAMDB. If the result of analysis is that the bill from the communications carrier is a bill to the user who has opened an account with the network bank that is the additional business of the ASP, then a user determination unit 83b verifies the applicable user from the user registration master database UMDB and stores the result in a user log ULG.

Next, a user account determination processor 83c verifies the applicable user based upon the user log ULG and a network bank depositor master database BDPMDB, which is a list of depositors of the network bank also being run by the ASP, and extracts information from a user account information database UADB.

A user payment processor 83d refers to the user account information database UADB, makes payment of the part of the billed amount from the communications carrier and stores the result in a user payment log UPLG. At the same time, the communications carrier remitting processor 85a executes processing for making a remittance to the financial institution used by the network carrier. A user account disbursement processor 83e of the ASP (one that is also engaging in network banking) refers to the recorded data in the user payment log UPLG, executes disbursement processing for withdrawing funds from the user account and rewrites the user account information database (UADB) based upon the result.

(e-4) Processing in Case where Communications Carrier Makes Payment to ASP

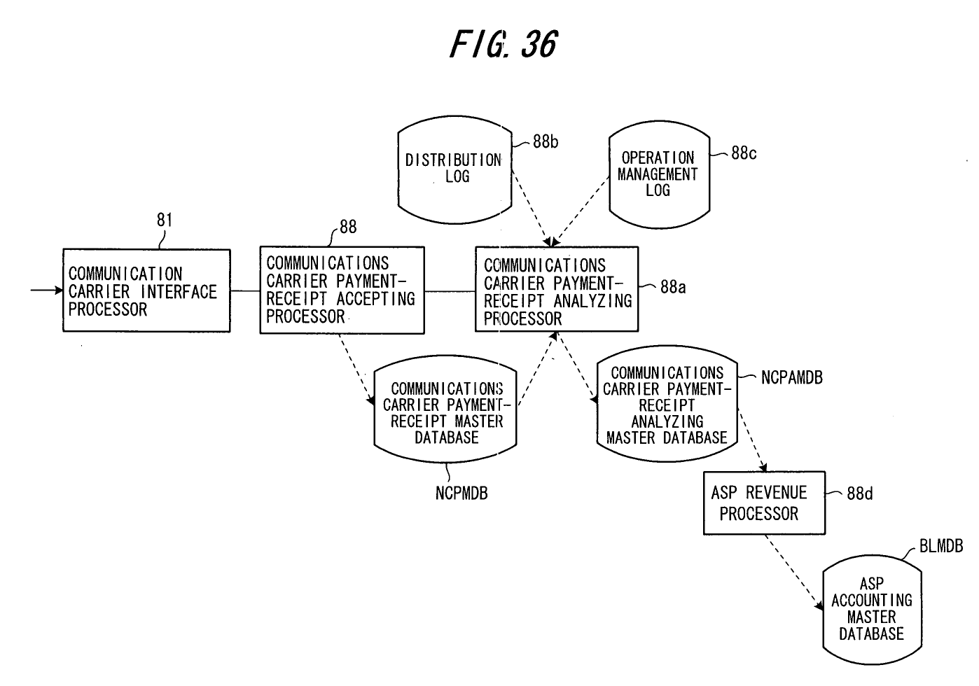

FIG. 36 is a diagram useful in describing processing in a case where a communications carrier makes payment to an ASP of an amount from which the communications carrier commission has been excluded when proxy collection of the service fee has been made in conformity with collection of a monthly communication fee by the communications carrier (e.g., 90% of the service fee becomes the income of the ASP).

The communications carrier payment-receipt accepting processor 88 accepts receipt of funds from the network carrier and stores the details in a communications carrier payment-receipt master database NCPMDB. Next, a communications carrier payment-receipt analyzing processor 88a coordinates the payment-receipt details (breakdown) from the communications carrier with a distribution log 88b and operation management log 88c storing the circumstances, etc., of service utilization and stores the result in a communications carrier payment-receipt analyzing master database NCPAMDB. An ASP revenue processor 88d executes accounting-related revenue processing based upon the communications carrier payment-receipt analyzing master database NCPAMDB and causes the result of processing to be reflected in the ASP accounting master database BLMDB.

(e-5) Processing in Case where Payment is made to Information Provider

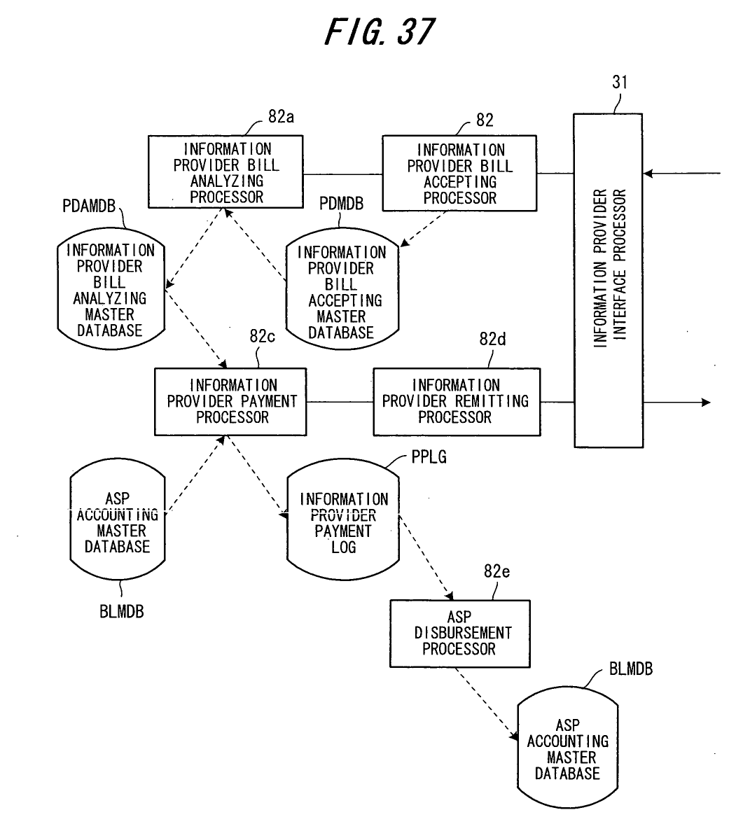

FIG. 37 is a diagram useful in describing processing in a case where payment is made to an information provider in response to billing for a user fee for content, etc., provided for this service by the information provider. Operation is similar also in a case where billing is made by a content provider.

The information provider bill accepting processor 82 accepts a bill from the information provider and stores the details thereof in an information provider bill accepting master database PDMDB. Next, the information provider bill analyzing processor 82a analyzes the details of the bill from the information provider and stores the result in an information provider bill analyzing master database PDAMDB. If the result of analysis is that the bill from the information provider is a fee for content provided for this service, then an information provider payment processor 82c executes the required payment procedure based upon an ASP accounting master database BLMDB and records the result in an information provider payment log PPLG. At the same time, an information provider remitting processor 82d executes processing for making a remittance to the financial institution used by the information provider. An ASP disbursement processor 82e executes accounting disbursement processing based upon the information provider payment log PPLG and causes the result to be reflected in the ASP accounting master database BLMDB.

(e-6) Processing in Case where Information Provider Makes Payment

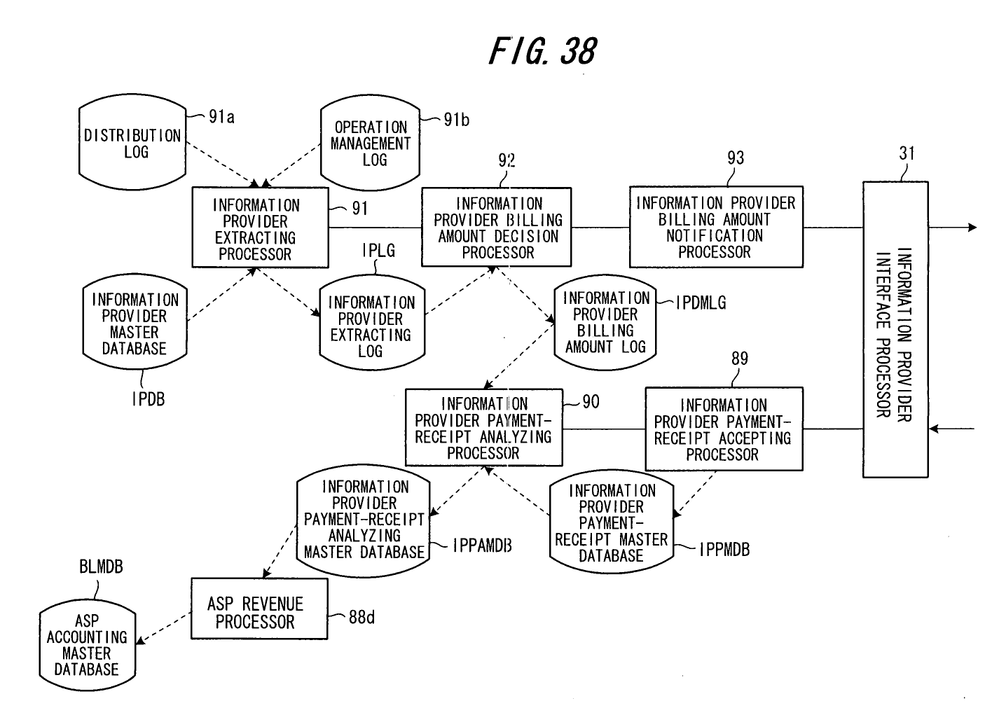

FIG. 38 is a diagram useful in describing processing in a case where an information provider is billed for cost of a service added on by an ASP and the information provider makes this payment.

An information provider extracting processor 91 of the ASP extracts a payment-requesting information provider based upon a distribution log 91a and operation management log 91b, which store the circumstances, etc., of service utilization, and the information provider master database IPDB in which the attributes of information providers are registered, and stores the result in an information provider extracting log IPLG. Next, an information provider billing amount decision processor 92 decides the amount to bill the applicable information provider and stores the result in an information provider billing amount log IPDMLG. At the same time, an information provider billing amount notification processor 93 reports the billing amount to the financial institution of the information provider.

The information provider payment-receipt accepting processor 89 accepts receipt of payment from the information provider and stores the details in an information provider payment-receipt master database IPPMDB. Next, an information provider payment-receipt analyzing processor 90 analyzes the payment-receipt details from the information provider upon coordinating with the information provider billing amount log IPDMLG and stores the result in an information provider payment-receipt analyzing master database IPPAMDB. The ASP revenue processor 88d executes accounting-related revenue processing based upon the information provider payment-receipt analyzing master database IPPAMDB and causes the result of processing to be reflected in the ASP accounting master database BLMDB.

(e-7) Settlement Process in Basic Processing Configurations 1 to 3

(1) Settlement processes S1 to S3

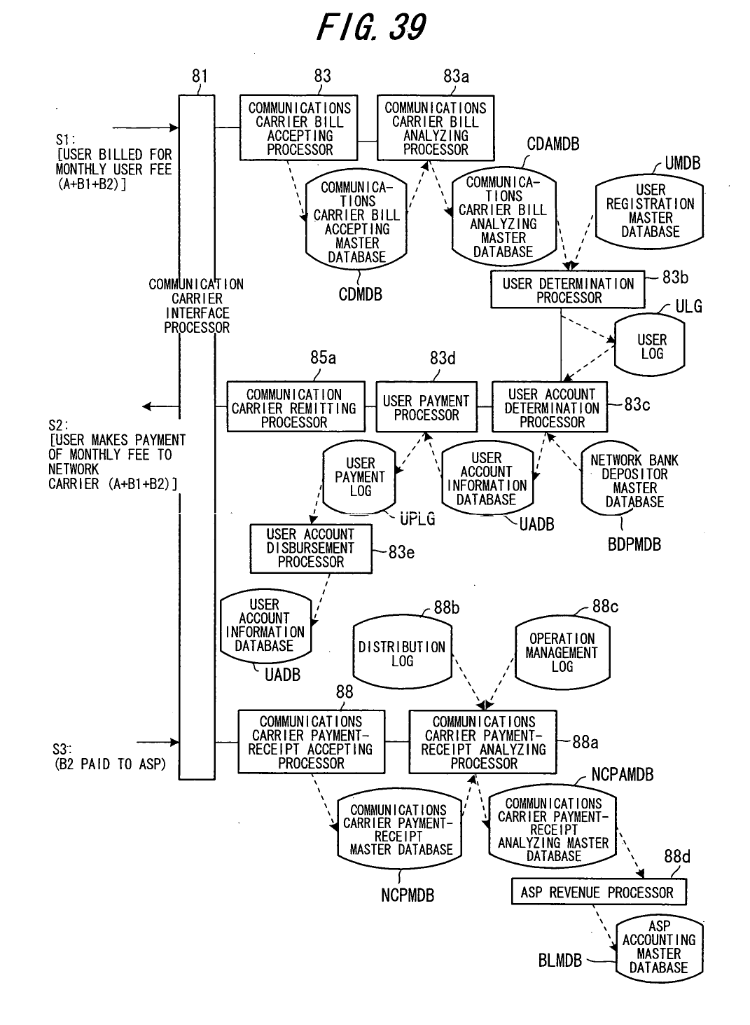

FIG. 39 is a diagram useful in describing processing of settlement process steps S1 to S3 illustrated in FIG. 27. This is processing that is a combination of the processing of FIGS. 35 and 36.

(2) Settlement processes S1, S2′, S2″

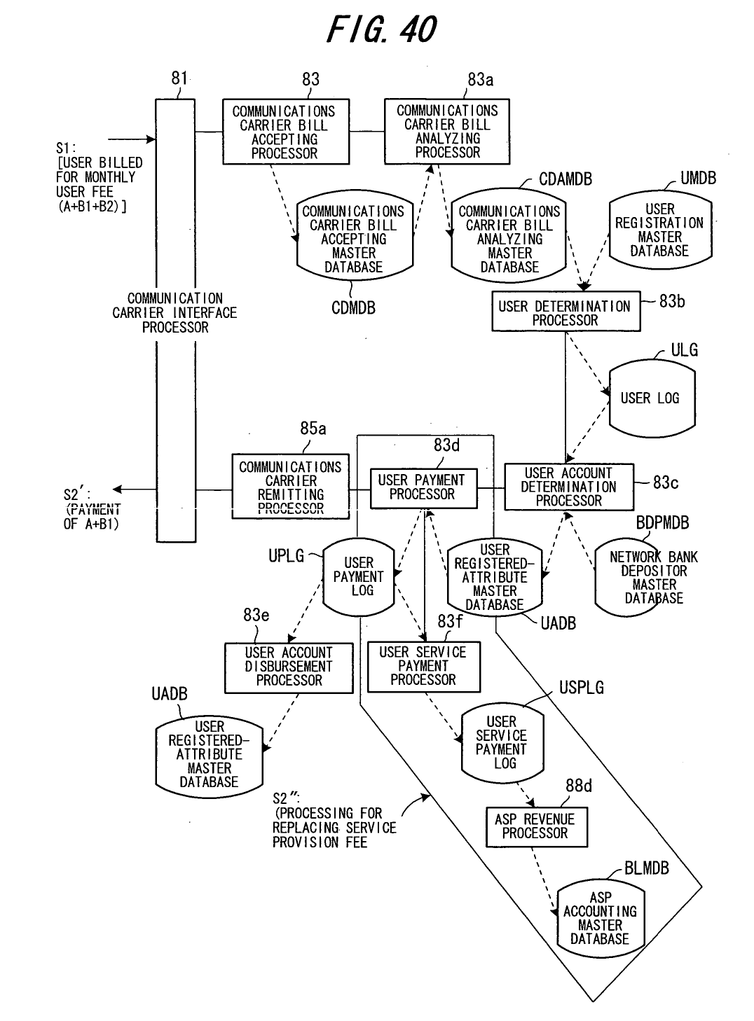

FIG. 40 is a diagram useful in describing processing of settlement process steps S1, S2′, S2″ illustrated in FIG. 28. This is processing that is a combination of the processing (S1, S2′) of FIG. 35 and processing (S2″) for replacing the service provision fee (B2) in network banking. The user payment processor 83d refers to the user account information database UADB, makes payment of an amount (=A+B) obtained by excluding B2 from the billed amount from the communications carrier and stores the result in the user payment log UPLG. At the same time, the communications carrier remitting processor 85a executes processing (S2′) for making a remittance to the financial institution used by the network carrier.

Next, a user service payment processor 83f executes processing for making payment of an amount (=B2) from the user account to the ASP account and records the result in a user service payment log USPLG. The ASP revenue processor 88d executes accounting-related revenue processing based upon the user service payment log USPLG and causes the result of processing to be reflected in the ASP accounting master database BLMDB (S2″).

(3) Settlement Processes S6, S7

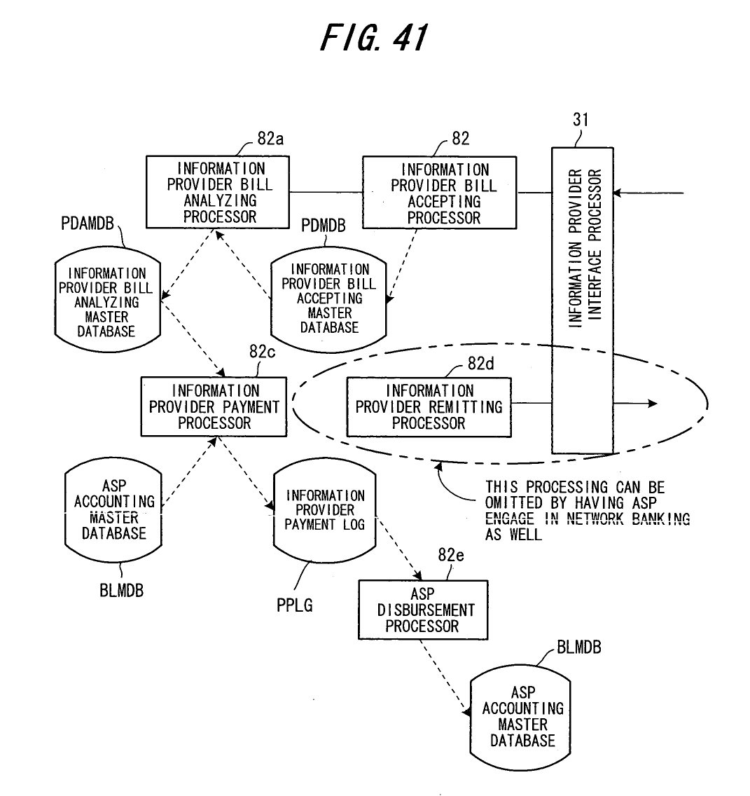

FIG. 41 is a diagram useful in describing processing of settlement process steps S6, S7 illustrated in FIG. 27. This is similar to the processing of FIG. 37. If it is assumed in this case that the ASP also engages in network banking and that the information provider has opened an account with the network bank, then the bank-to-bank settlement processing S7 can be omitted. That is, the bank-to-bank settlement process between the ASP and the information provider can be made inherent as processing within the network bank, thereby making it possible to raise the efficiency of business processing.

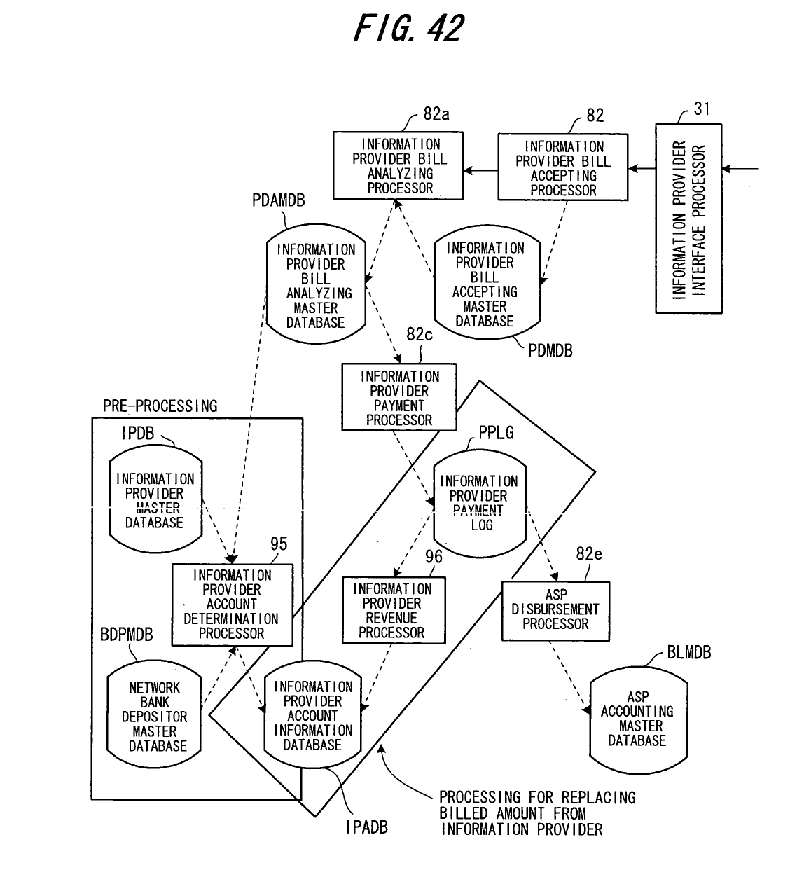

FIG. 42 is a diagram useful in describing processing for a case where an ASP also engages in network banking. The information provider bill accepting processor 82 accepts a bill from the information provider and stores the details thereof in the information provider bill accepting master database PDMDB. Next, the information provider bill analyzing processor 82a analyzes the details of the bill from the information provider and stores the result in the information provider bill analyzing master database PDAMDB. If the result of analysis is that the bill from the information provider is a fee for content provided for this service, then the information provider payment processor 82c executes the required payment procedure based upon the information provider bill analyzing master database PDAMDB and records the result in an information provider payment log PPLG. The ASP payment processor 82e executes accounting disbursement processing based upon the information provider payment log PPLG and causes the result to be reflected in the ASP accounting master database BLMDB.

An information provider account determination processor 95 verifies the applicable information provider in advance based upon the information provider master database IPDB and the network bank depositor master database BDPMDB, which is a list of depositors of the network bank also being run by the ASP, and extracts information from an information provider account information database IPADB. An information provider revenue processor 96 refers to the data stored in the information provider payment log PPLG, executes revenue processing for revenue equivalent to the billed amount paid by the ASP and causes the result to be reflected in the information provider account information database IPADB.

(4) Settlement Processes S11 to S12

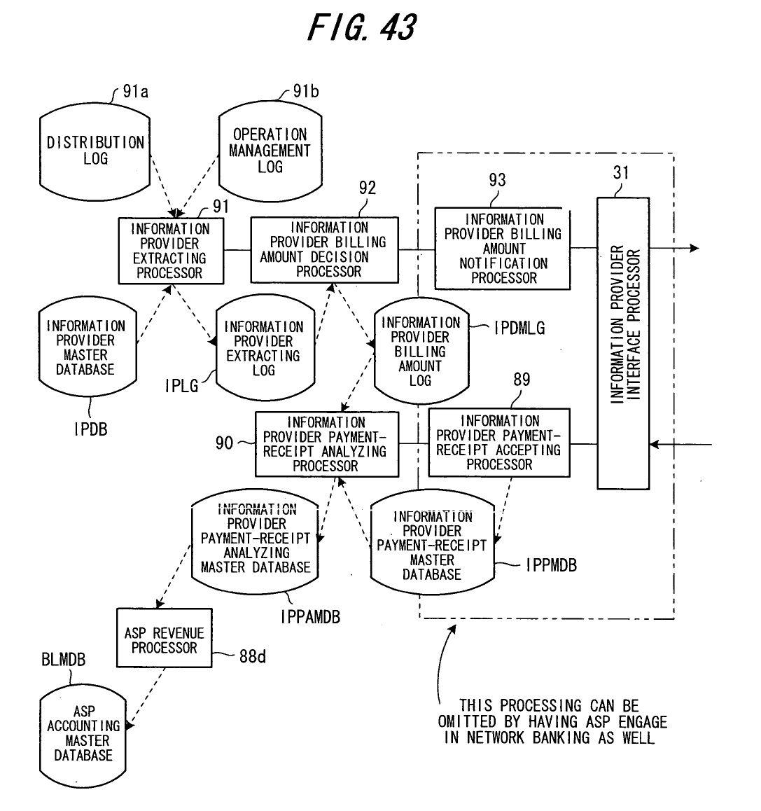

FIG. 43 is a diagram useful in describing processing of settlement process steps S11, S12 illustrated in FIG. 31. This is similar to the processing of FIG. 38. If it is assumed in this case that the ASP also engages in network banking and that the information provider has opened an account with the network bank, then the bank-to-bank settlement processing S11, S12 can be omitted. That is, the bank-to-bank settlement process between the ASP and the information provider can be made inherent as processing within the network bank, thereby making it possible to raise the efficiency of business processing.

FIG. 44 is a diagram useful in describing processing for a case where an ASP also engages in network banking. The information provider extracting processor 91 of the ASP extracts a payment-requesting information provider based upon the distribution log 91a and operation management log 91b, which store the circumstances, etc., of service utilization, and the information provider master database IPDB in which the attributes of information providers are registered, and stores the result in the information provider extracting log IPLG. Next, the information provider billing amount decision processor 92 decides the amount to bill the applicable information provider and stores the result in the information provider billing amount log IPDMLG. The information provider payment processor 82c refers to the data recorded in the information provider billing amount log IPDMLG and creates the information provider payment log PPLG. An ASP revenue processor 82f of the executes accounting-related revenue processing based upon the information provider payment log PPLG and causes the result of processing to be reflected in the ASP accounting master database BLMDB.

The information provider account determination processor 95 verifies the applicable information provider in advance based upon the information provider master database IPDB and the network bank depositor master database BDPMDB, which is a list of depositors of the network bank also being run by the ASP, and extracts information from an information provider account information database IPADB.

An information provider disbursement processor 97 refers to the information provider payment log PPLG, executes processing for disbursing the amount of payment to be paid to the ASP and causes the result to be reflected in the information provider account information database IPADB.

### (D) Third Embodiment

(a) Cooperation with Information Provider (Game Provider)

This embodiment includes a case where the nature of a service (game content) provided is agreed upon between the information distributing server system (ASP) 14 and information provider 15, and a case where the nature of a service (game content) provided by the information provider is decided based upon information that the ASP has reported to the information provider.

A. <<Play-Alone-Type Game>>

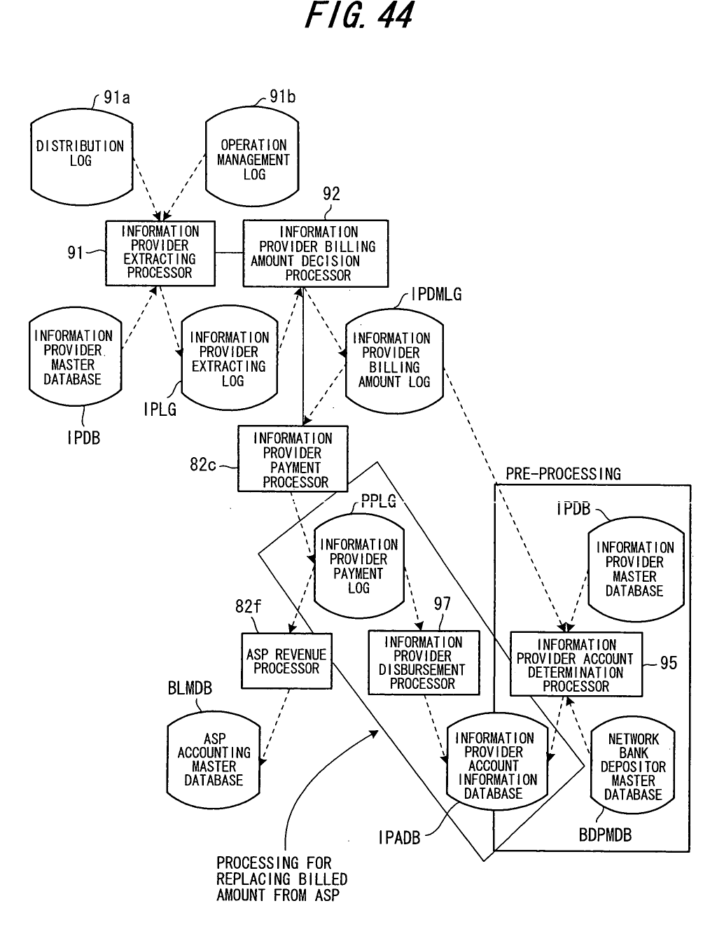

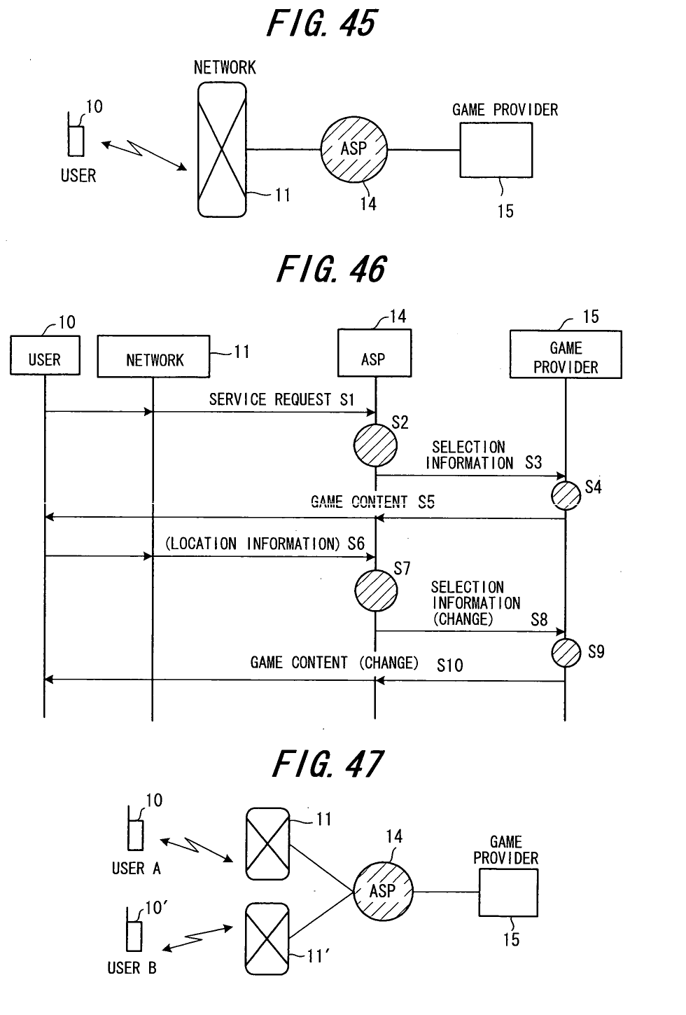

FIG. 45 is a conceptual view of this embodiment, and FIG. 46 illustrates the sequence.

The user 10 requests use of the game service, inclusive of the game type (S1).

The ASP 14 creates selection information, which is for specifying the nature of the game, from the telephone number (or IP address), time and loction information of the user 10 (S2), and notifies the game provider of the selection information together with the game type specified by user (S3).

The game provider decides the nature of the game and conditions, etc., based upon the selection information specified by the ASP (S4), and reports game content conforming to this decision to the user 10 via the ASP (S5).

The ASP 14 thenceforth acquires information indicating the circumstances of the user 10, e.g., the user location information, obtains position displacement from this location information (S6), creates selection information, which changes the nature of the game, based upon the position displacement and information such as time (S7) and reports the selection information to the game provider (S8). The information provider 15 changes the nature and conditions of the game currently being utilized by the user 10 (S9) and reports the details of the change to the user 10 via the ASP (S10). The sequence of S6 to S10 is thenceforth repeated appropriately.

This embodiment is applicable to play-alone-type games such as the ones described below by way of example.

(1) In a time-limit-type game such as a game that involves dealing with a time bomb, the type of bomb and the time limit, etc., are changed based upon user location information and time.

(2) In a game in which a balloon (a paper plane) or the like is caused to move by wind power, wind power and direction and the number of balloons are changed, or a limitation on time to arrival at a destination is changed, based upon various information about the user.

(3) In a game such as a jigsaw puzzle or building-block game, the number of pieces or number of blocks is changed, or limit on time to completion is changed, based upon various information about the user.

(4) In an automobile driving simulation or in a ship or airplane piloting simulation, weather conditions or difficulty conditions are changes based upon various information about the user.

(5) In a nurturing game for growing a virtual forest or raising a virtual animal, weather conditions, types of trees and growth process are changed based upon various information about the user.

(6) In an action game centered on a hero, the number of characters who appear and an accurate characterization of these characters are change based upon various information about the user.

<<Play-Against-Type Game>>

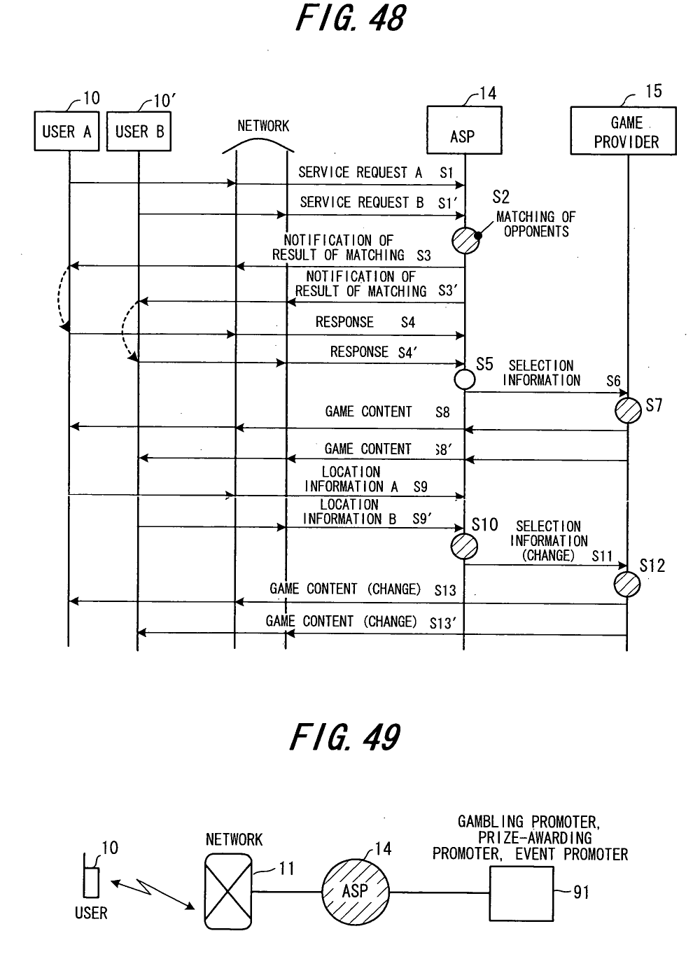

FIG. 47 is a conceptual view of this embodiment, and FIG. 48 illustrates the sequence.

Multiple users A, B request use of the game service, inclusive of the game type (S1, S1′).

The ASP matches opponents from the multiple users A, B (S2) and so notifies each of these users (S3, S3′).

Based upon the responses from the selected opponents (S4, S4′), the ASP creates selection information, which specifies the nature of the game, based upon telephone numbers (or IP addresses), times and location information (S5) and reports this information to the information provider 15 together with the game type specified by the users (S6).

The information provider 15 decides the nature of the game and conditions, etc., based upon the selection information specified by the ASP 14 (S7), and reports game content conforming to this decision to the opponents A, B via the ASP (S8, S8′).

The ASP 14 thenceforth acquires information indicating the circumstances of the users A, B, e.g., the user location information, obtains position displacements from this location information (S9, S9′), creates selection information, which changes the nature of the game, based upon the position displacements and information such as time (S10) and reports the selection information to the game provider (S11). The information provider 15 changes the nature and conditions of the game currently being utilized by the users A, B (S12) and reports the details of the change to the opponents A, B via the ASP (S13, S13′). The sequence of S9, S9′ to S13, S13′ is thenceforth repeated appropriately.

This embodiment is applicable to play-against-type games such as the ones described below by way of example.

(1) In a combat game (war game), types and quantities of weapons that can be used, the effective range of heavy weapons such as missiles, the effects of use of weapons and combat time, etc., are changed based upon location information and times of multiple users. Further, if a user wishes a high position (that of a general) in a war game or the like, then this would be allowed by the necessary value equivalent (the game fee would be raised).

(2) In a mahjong game, the nature of playing tiles is changed based upon the location information and times of the users (four players).

(3) In a two-party confrontational game such as chess, go or shogi, waiting time or the like is changed based upon information indicating the attributes of the users (two players).

Thus, in accordance with this embodiment, even though the game is the same in the provision of a game service in cooperation with a game provider, the nature of the game becomes one that cannot be predicted by the user and it is possible to maintain the apparent freshness of game content and raise the frequency of game utilization.

Entertainment value can be enhanced by changing the nature of the game constantly based upon movement and displacement of the user during the game.

As a result of the above, the game provider can expect the following repercussion effects:
a. prevent game software from becoming out of date;
b. assure the profitability of game software; and
c. stabilize profitability by improving the game-software development cycle.

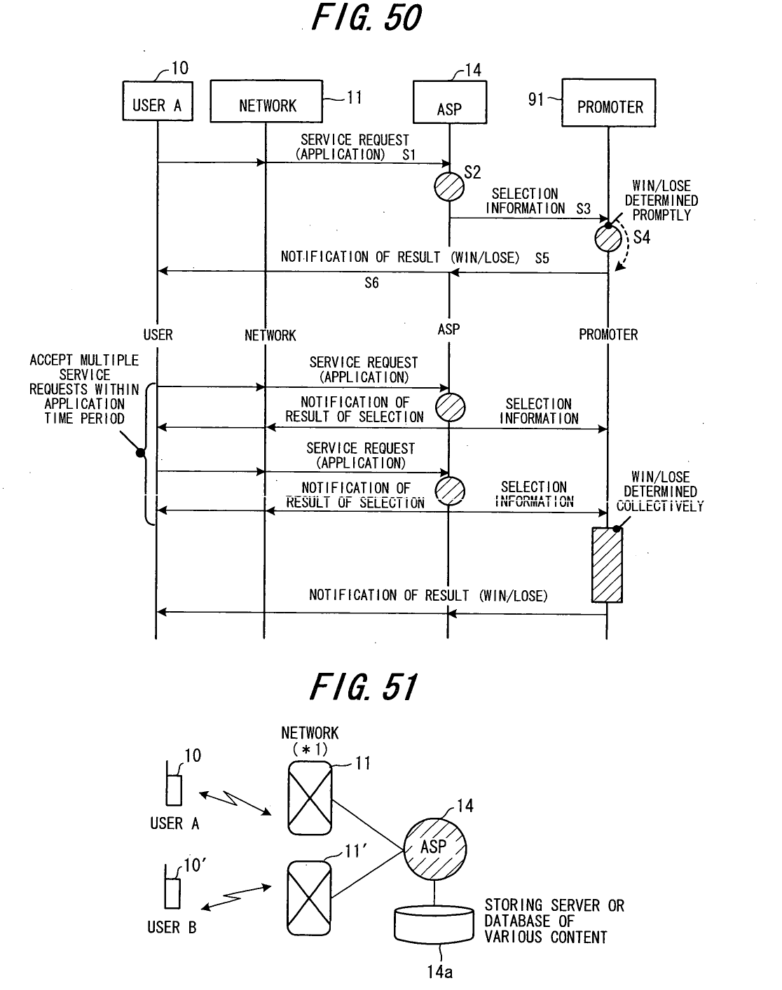

(b) FIG. 49 is a conceptual view of an embodiment of cooperation among promoters of gambling, prize-awarding and event (especially ticket sales) enterprises, and FIG. 50 illustrates the related sequence diagram.

The user 10 requests the ASP 14 for utilization of a service such as gambling or prize awarding to which the user is to apply (S1). The ASP creates selection information, which will serve as a drawing number of entry number, based upon the telephone number (or IP address) of the user 10, entry time and location information, etc. (S2), and reports this selection information to a promoter 91 of gambling or the like (S3).

The promoter 91 of gambling or the like decides hit or miss, win or lose, etc., promptly based upon the selection information specified by the ASP 14 (S4) and reports this to the ASP (S5).

The ASP notifies the applying user of the created drawing number or entry number together with the win/lose (S6).

Furthermore, the promoter of gambling or the like decides whether there is a winner or not following the end of the application period and reports the result to each user. Further, as shown in the lower part of FIG. 50, a modification is possible in which a plurality of service requests are accepted in the application period and win/lose is reported to the user 10.

In accordance with this embodiment, the following services can be provided by cooperation between a gambling promoter and a promoter of a prize-awarding enterprise, etc.

(1) In a case where victory or defeat in a sports competition is the subject of gambling, it is possible to specify the location of the event, such as a race track, the location of a ski jump or a soccer field. Accordingly, when the gambling promoter adds on the location of the user (terminal) as an entry condition, the ASP discriminates the validity of the applicant, whereby the arbitrariness of the user can be excluded and it becomes possible to realize a gambling enterprise in which only a race track is the target of gambling. Further, the ASP cooperates with the gambling promoter and generates a magnification that conforms to the progress of the competition, whereby entry up to the end of the competition becomes possible.

(2) By discriminating multiple entries from the same applicant, the ASP can, in case of a sign-up enterprise that does not allow multiple entries, report only valid entries to the gambling promoter or prize-awarding promoter, thereby decreasing the load upon the promoter side. In particular, it is possible to prevent congestion between the system on the promoter side and a communication system of ticket sales based upon “first come, first served” or bulk sign-up by a single individual.

(3) In accordance with this embodiment, the ASP applies linear or non-linear mapping, based upon various information about a user, to a drawing number or entry number prevailing when the user applies, thereby making it possible to exclude user arbitrariness and realize provision of fairness in balloting based upon not knowing who will be the winner.

(4) Information relating to privacy, such as the telephone number of a user, is not delivered to the gambling promoter. Accordingly, psychological factors can be excluded. For example, a user need not be concerned with anonymous participation or other utilization circumstances of the user.

(c) Provision of Added Value to Two-Party Communication by ASP

FIG. 51 is a conceptual view of an embodiment in which added value is applied to communication between a user A and a user B.

A. <<Application to Communication not Requiring Quick Response (e-mail, etc.)

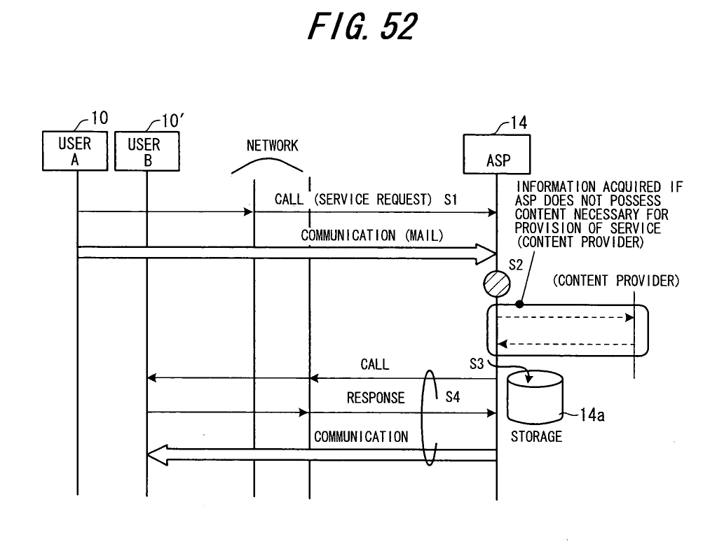

FIG. 52 is a basic sequence in case of application to communication that does not require quick response, namely communication such as by e-mail.

User A requests the ASP for utilization of service, inclusive of the type of service desired (S1).

Based upon the telephone number (or IP address or mail address), time and location information of the user 10, the mail address of the other communicating party and the length of text, etc., the ASP 14 selects content (music, background images, etc.) to be added on (S2), adds the selected content to the body of the mail and stores the result in storage 14a. The ASP transmits the stored body of the mail under predetermined conditions to the communicating party B specified by user A.

The following services can be realized in this embodiment:

(1) Based upon various information concerning the user, still-picture and moving-picture mail can be provided with added value by adding on various music as background music or by adding on an image library of scenery or the like to the background screen of text mail.

(2) In machine communication with a pet robot, a message consisting of a pseudo-conversation with the robot is created from intervals of communication with the robot, length of communication and the nature of past conversions in addition to various information concerning the user, and the ASP adds this conversational message to camera video from the robot, thereby personifying the pet robot.

B. <<Application to Communication not Requiring Quick Response (Bulletin Board Service, etc.)

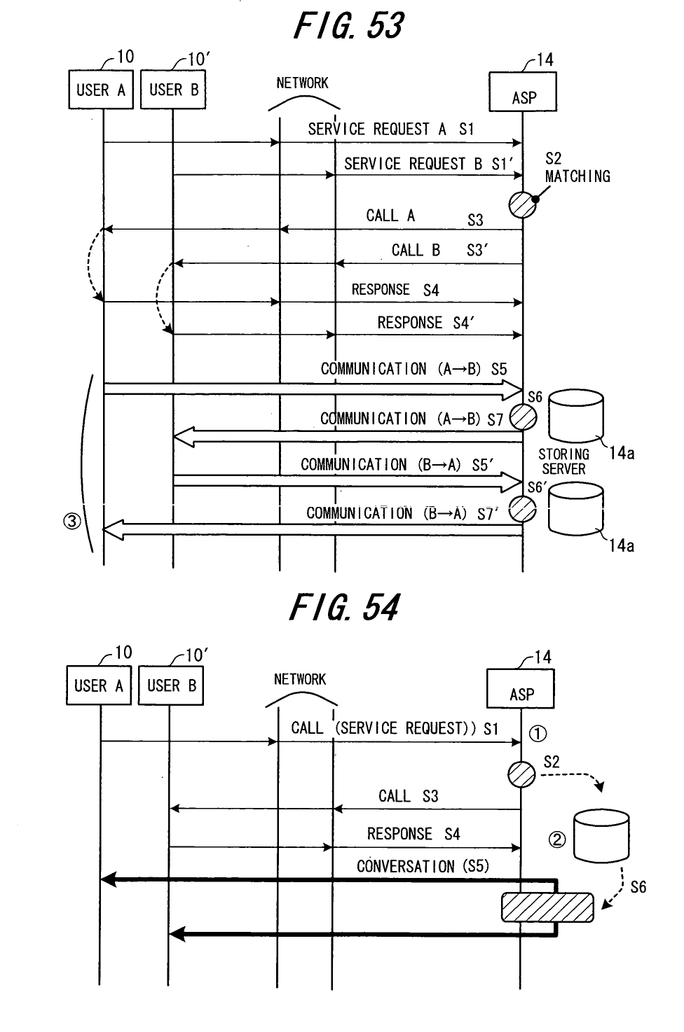

FIG. 53 is a basic sequence in case of application to communication that does not require quick response, namely communication such by bulletin board.

Multiple users A, B register utilization of a service for seeking conversational partners with the ASP 14 (S1, S1′). The ASP 14 carries out matching (S2) based upon various information concerning the users A, B and so notifies the two selected parties (S3, S3′; S4, S4′).

Users A, B so notified by the ASP 14 send bodies of mail with the ASP 14 serving as the artificial communication party (S5, S5′), and the ASP 14 adds prescribed content onto the bodies of the mail in a manner similar to that of FIG. 52 (S6, S6′) and transmit the bodies of the mail to the communicating parties in suitable fashion (S7, S7′).

By virtue of this embodiment, the service user is capable of communicating with an unknown person without disclosing privacy-related information such as a mail address. In other words, by serving as an intermediary in two-party communication and applying added value, the ASP 14 can realize a service different from convention chat rooms or dating site.

C. <<Application to Communication Requiring Quick Response (Ordinary Voice Conversation, etc.)

FIG. 54 is a basic sequence in case of application to communication that requires quick response, namely a voice conversation service.

At the same time as a call is originated, user A sends the ASP 14 a request that includes the type of service desired. Based upon user telephone number (or IP address), time and location information and the telephone number (or IP address) of the communicating party, the ASP 14 selects the content (music, circumstantial sounds, environmental sounds, etc.) to be added onto two-way conversation (S2). At the same time, the ASP 14 calls party B who is to communicate with user A (S3) and, in response to a reply (S4), adds the above-mentioned content (S6) onto the two-way conversation.

The following services can be realized by this embodiment:

By applying “guidance” such as present location and direction of travel of a user before a conversation on the basis of user location information (movement displacement, etc.), both the user and the conversing party can have their positions recognized accurately.

Further, music such as background music and various environmental sounds can be applied as background to a conversation intentionally based upon various information concerning the user.

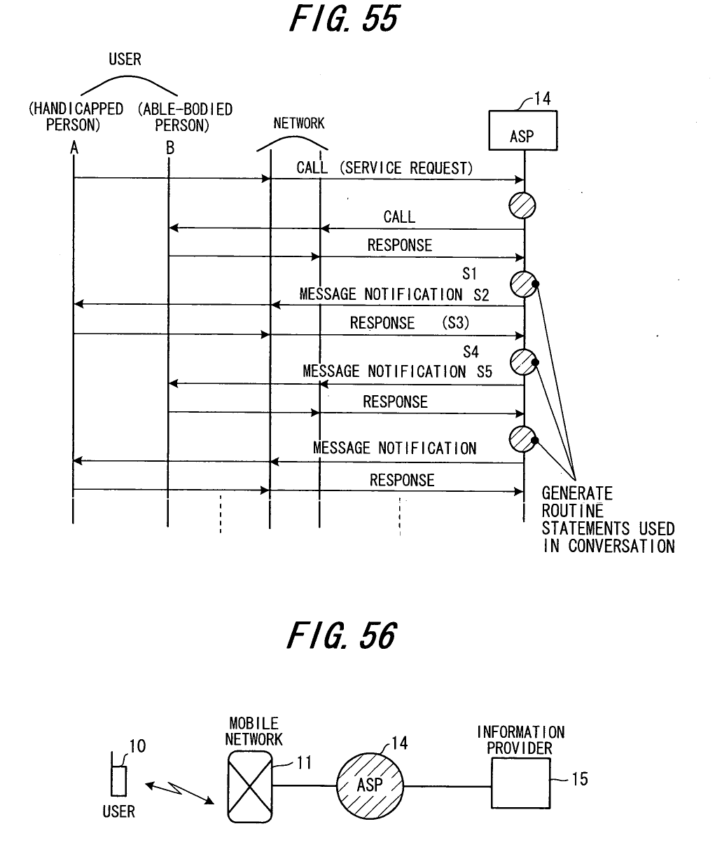

The present invention also makes it possible to achieve smooth communication between an individual having a disability, such as a speech impediment, and an able-bodied individual. FIG. 55 illustrates the sequence. The ASP 14 generates routine statements used in communication conforming to the circumstances of the users (handicapped person A and able-bodied person B) (S1) and changes the specifics of these statements depending upon a change in the specifics of the conversation.

The ASP 14 notifies the handicapped person A of information inclusive of a conversational message and choices (numbers) for selecting user reactions to this message (S2). The handicapped person A replies to the reported message by making a selection from numbers specified (S3).

On the basis of the reply from the handicapped person A, the ASP 14 generates the specifics of the next message to be communicated and notifies the other party of this message and of choices (S5).

Smooth communication between handicapped person A and able-bodied person B can be achieved by subsequently repeated the above-described process.

(d) Provision of Added Value to Information Provider

FIG. 56 is a conceptual view of an embodiment in which an information provider is provided with added value for enhancing effectiveness of information distribution from a retailer or distributor.

A. <<Active-Type Service>>

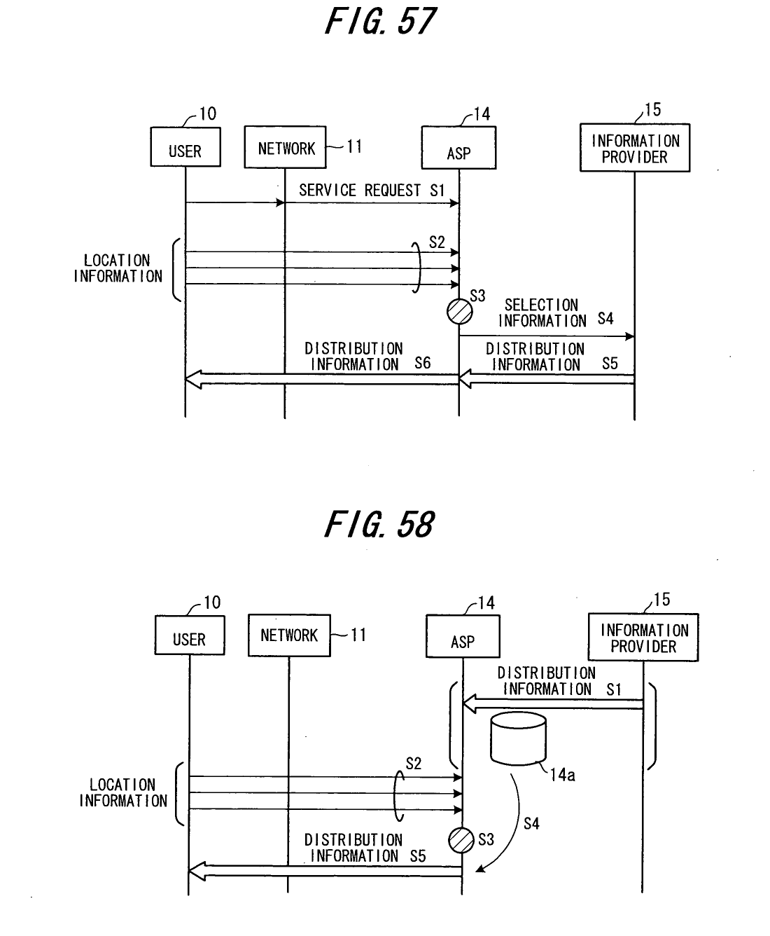

FIG. 57 is a diagram useful in describing the sequence of an active-type service.

The user 10 registers attributes, etc., which are desired for distribution, with the ASP 14 in advance.

Upon receiving the service request from the user 10′, the ASP 14 performs matching with the information provider 15 that conforms to the wishes of this user (S1). Further, the ASP receives user location information from the user (S2). In a case where electronic coupon information is distributed to a user, who is located in a distribution area specified by the information provider 15, based upon the location information, the ASP obtains a discontinuous discount rate based upon various user information (S3) and reports the result to the information provider 15 (S4).

On the basis of the information from the ASP 14, the information provider 15 edits the specifics of distribution user by user and reports the result to the ASP 14. The latter transmits the distribution information to the user (S6).

B. <<Passive-Type Service>>

FIG. 58 is a diagram useful in describing the sequence of a passive-type service.

Information distributed from the information provider 15 is stored in storage 14a by the ASP 14 (S1). Upon receiving the service request from the user 10, the ASP 14 performs matching with the information provider 15 that conforms to the wishes of this user. Further, the ASP receives user location information from the user (S2). In a case where electronic coupon information is distributed to a user, who is located in a distribution area specified by the information provider 15, based upon the location information, the ASP obtains a discontinuous discount rate based upon various user information (S3). In accordance with the result, the ASP extracts the applicable distribution information in the distribution information obtained from the information provider and stored by the ASP (S4) and transmits the distribution information to the applicable user (S5).

A method of enhancing information distribution in a mobile environment by predicting travel displacement of a user (terminal) has already been proposed. However, the present embodiment endows information, which is distributed or reported, with non-standardized change, and makes it possible to enhance the effect of viewing distributed information, i.e., the effect of distribution. As a result, it is possible to provide repercussion effects for raising the frequency with which a communication service is utilized and enhancing the pulling power of a store (sales).

Thus, in accordance with the present invention as described above, a variety of formal information in communications (terminal location information, outgoing-call time, calling-party number, called-party number, length of mail text and type of media, etc.) is mapped, and the category or specifics of a communication service is generated or decided based upon the result of mapping, thereby making it possible to achieve a communication service of a nature entirely different from that of the prior art. In other words, “discontinuity” or “uncertainty” is created by mapping from formal content possessed by various information, thereby making it possible to provide a communication service with elements of “surprise” and “changeability”, which have not been achieved in communication services heretofore. As a result, a new form of communication service market can be expected.

Further, according to the present invention, an information provider such as a provider of content inclusive of game software can apply a change to standardized content provided to a user or distributed, and the user can enjoy a service that provides or distributes “unexpected” informational content.

As a result, enhanced effectness of distribution can be expected as a secondary advantage.

As many apparently widely different embodiments of the present invention can be made without departing from the spirit and scope thereof, it is to be understood that the invention is not limited to the specific embodiments thereof except as defined in the appended claims.

1. A communication service providing method for providing, by communication, a service requested by a user, comprising the steps of:
mapping information that has been entered in order that a user may receive provision of service, or information that has been gathered or acquired in the course of execution of a call connection or a communication service;
generating added value based upon the result of mapping obtained; and applying the added value to the service requested by the user and providing the service to the user.

2. A communication service providing method for providing, by communication, a service requested by a user, comprising the steps of:
mapping information that has been entered in order that a user may receive provision of service, or information that has been gathered or acquired in the course of execution of a call connection or a communication service;
modifying the service, or the content thereof, which is provided by an information provider, based upon the result of mapping obtained; and
providing the modified service or content thereof to the user.

3. A communication service providing method for providing, by communication, a service requested by a user, comprising the steps of:
mapping information that has been entered in order that a user may receive provision of service, or information that has been gathered or acquired in the course of execution of a call connection or a communication service;
predicting an effective information distribution method based upon the mapped result obtained and notifying an information provider of this method;
receiving distributed information, which has been created taking the distribution method into account, from the information provider; and
providing this distributed information to the user.

4. The method according to claim 1, further comprising the steps of:
storing correspondence between services and mapping functions in advance and
selecting a mapping function that conforms to a requested service; and
applying a conversion to input information using this selected mapping function.

5. The method according to claim 4, further comprising the steps of:
storing correspondence between services and input information in advance; and
applying a conversion to input information, which conforms to a requested service, using the mapping function.

6. The method according to claim 1, further comprising a step of receiving user reaction to provision of a service, analyzing this user reaction and outputting the result.

7. The method according to claim 1, further comprising a step of operating a network bank, billing for a fee between parties concerned, making payment in response to this billing and executing automatic withdrawal of the fee.

8. A communication service providing apparatus for providing, by communication, a service requested by a user, comprising:
converting means for mapping and converting information that has been entered in order that a user may receive provision of service, or information that has been gathered or acquired in the course of execution of a call connection or a communication service;
means for generating added value based upon the result of mapping obtained; and
means for applying the added value to the service requested by the user and providing the service to the user.

9. A communication service providing apparatus for providing, by communication, a service requested by a user, comprising:
converting means for mapping and converting information that has been entered in order that a user may receive provision of service, or information that has been gathered or acquired in the course of execution of a call connection or a communication service;
means for modifying the service, or the content thereof, which is provided by an information provider, based upon the result of mapping obtained; and
means for providing the modified service or content thereof to the user.

10. A communication service providing apparatus for providing, by communication, a service requested by a user, comprising:
converting means for mapping and converting information that has been entered in order that a user may receive provision of service, or information that has been gathered or acquired in the course of execution of a call connection or a communication service;
means for predicting an effective information distribution method based upon the mapped result obtained;
means for notifying an information provider of result of the prediction;
means for receiving distributed information, which has been created taking the distribution method into account, from the information provider; and
means for providing this distributed information to the user.

11. The apparatus according to claim 8, further comprising:
a function selecting unit for storing correspondence between services and mapping functions in advance and selecting a mapping function that conforms to a requested service; and
an input information selecting unit for storing correspondence between services and input information in advance and selecting input information that conforms to a requested service;
wherein said converting means applies a conversion to the selected input information using the mapping function that has been selected.

12. The apparatus according to claim 8, further comprising means for receiving user reaction to provision of a service, analyzing this user reaction and outputting the result.

13. The apparatus according to claim 8, further comprising means for billing for a fee between parties concerned, making payment in response to this billing and executing automatic withdrawal of the fee.

14. The method according to claim 2, further comprising the steps of:
storing correspondence between services and mapping functions in advance and selecting a mapping function that conforms to a requested service; and
applying a conversion to input information using this selected mapping function.

15. The method according to claim 3, further comprising the steps of:
storing correspondence between services and mapping functions in advance and selecting a mapping function that conforms to a requested service; and
applying a conversion to input information using this selected mapping function.

16. The method according to claim 2, further comprising a step of receiving user reaction to provision of a service, analyzing this user reaction and outputting the result.

17. The method according to claim 3, further comprising a step of receiving user reaction to provision of a service, analyzing this user reaction and outputting the result.

18. The method according to claim 2, further comprising a step of operating a network bank, billing for a fee between parties concerned, making payment in response to this billing and executing automatic withdrawal of the fee.

19. The method according to claim 3, further comprising a step of operating a network bank, billing for a fee between parties concerned, making payment in response to this billing and executing automatic withdrawal of the fee.

20. The apparatus according to claim 9, further comprising:
a function selecting unit for storing correspondence between services and mapping functions in advance and selecting a mapping function that conforms to a requested service; and
an input information selecting unit for storing correspondence between services and input information in advance and selecting input information that conforms to a requested service;
wherein said converting means applies a conversion to the selected input information using the mapping function that has been selected.
